(19) United States
(12) Patent Application Publication
(10) Pub. No.: US 2020/0328540 A1
(43) Pub. Date: Oct. 15, 2020

(54) CONNECTOR, HEADER, AND SOCKET

(71) Applicants: Yoji MIYAZAKI, Mie (JP); Yuki MINAI, Mie (JP)

(72) Inventors: Yoji MIYAZAKI, Mie (JP); Yuki MINAI, Mie (JP)

(73) Assignee: PANASONIC INTELLECTUAL PROPERTY MANAGEMENT CO., LTD., Osaka (JP)

(21) Appl. No.: 16/092,413

(22) PCT Filed: Apr. 13, 2017
(86) PCT No.: PCT/JP2017/015049

§ 371 Date: Oct. 9, 2018

(30) Foreign Application Priority Data
Apr. 28, 2016 (JP) 2016-091930

(51) Int. Cl. H01R 12/71; H01R 13/11; H01R 13/20

(52) U.S. Cl. CPC H01R 12/716; H01R 13/20; H01R 13/11

(57) ABSTRACT

A connector includes a socket including a socket housing having a substantially rectangular shape. The socket housing includes a first socket terminal and a second socket terminal disposed in the socket housing. A width of the second socket terminal is larger than a width of the first socket terminal. The connector further includes a header including a header housing having a substantially rectangular shape. The header housing includes a first header terminal and a second header terminal disposed in the header housing. A width of the second header terminal is larger than a width of the first header terminal. The second socket terminal includes one second socket terminal and another socket terminal. The one second socket terminal is disposed on one side in the longitudinal direction of the socket housing and on one side in the short direction. Another second socket terminal is disposed on another side in the longitudinal direction and on another side in the short direction of the socket housing.

### TECHNICAL FIELD

The present disclosure relates to a connector, a header, and a socket.

### BACKGROUND ART

Conventional connectors are known to include a socket and a header. The socket includes a socket housing having a substantially rectangular shape and socket-side signal terminals and socket-side power source terminals are disposed in the socket housing. The header includes a header housing having a substantially rectangular shape, and header-side signal terminals and header-side power source terminals are disposed in the header housing (for example, see PTL 1).

In PTL 1, the socket-side power source terminals have a width larger than a width of the socket-side signal terminals, and the header-side power source terminals have a width larger than a width of the header-side signal terminals. Therefore, a compact connector is achieved compared with connectors commonly using a plurality of terminals as one power source terminal.

### CITATION LIST

### Patent Literature

PTL 1: Unexamined Japanese Patent Publication No. 2016-039129

### SUMMARY OF THE INVENTION

A connector of the present disclosure includes a socket including a socket housing having a substantially rectangular shape. The socket housing includes a first socket terminal and a second socket terminal disposed in the socket housing. The second socket terminals are wider than the first socket terminals.

The connector further includes a header including a header housing having a substantially rectangular shape. The header housing includes first header terminals and second header terminals disposed in the header housing. The second header terminals are wider than the first header terminals.

The second socket terminals include one group of second socket terminals and the other group of second socket terminals. The one group of second socket terminals is disposed on one side in the longitudinal direction and on one side in the short direction of the socket housing. The other group of second socket terminals is disposed on the other side in the longitudinal direction and on other side in the short direction of the socket housing.

A socket of the present disclosure includes a socket housing having a substantially rectangular shape. First socket terminals and second socket terminals are disposed in the socket housing. The second socket terminals are wider than the first socket terminals.

The second socket terminals include one group of second socket terminals and the other group of second socket terminals. The one second socket terminal is disposed on one side in the longitudinal direction and on one side in the short direction of the socket housing. Disposed on other side in the longitudinal direction and on other side in the short direction of the socket housing.

The header according to the present disclosure includes a header housing having a substantially rectangular shape. The header housing includes first header terminals and second header terminals disposed in the header housing. The second header terminals are wider than the first header terminals.

The second header terminal includes one group of second header terminals and the other group of second header terminals. The second one group of header terminals is disposed on one side in the longitudinal direction and on one side in the short direction of the header housing. The other group of second header terminals is disposed on the other side in the longitudinal direction and on the other side in the short direction of the header housing.

### BRIEF DESCRIPTION OF DRAWINGS

FIG. 1 is a perspective view of a header of a connector according to an exemplary embodiment of the present disclosure viewed from a back side.

FIG. 2 is a perspective view of the header of the connector according to the exemplary embodiment of the present disclosure viewed from a front side.

FIG. 3 illustrates the header of the connector according to the exemplary embodiment of the present disclosure, in which part (a) is a side view, part (b) is an underside view, part (c) is a plan view, and part (d) is a front view.

FIG. 4 is a perspective view of a header housing of the connector according to the exemplary embodiment of the present disclosure viewed from a back side.

FIG. 5 is a perspective view of the header housing of the connector according to the exemplary embodiment of the present disclosure viewed from a front side.

FIG. 6 illustrates the header housing of the connector according to the exemplary embodiment of the present disclosure, in which part (a) is a side view, part (b) is an underside view, part (c) is a plan view, and part (d) is a front view.

FIG. 7 illustrates a first header terminal of the connector according to the exemplary embodiment of the present disclosure, in which part (a) is a first perspective view, part (b) is a second perspective view, part (c) is a third perspective view, and part (d) is a fourth perspective view.

FIG. 8 illustrates the first header terminal of the connector according to the exemplary embodiment of the present disclosure, in which part (a) is a side view, part (b) is a plan view, part (c) is an underside view, part (d) is a front view, and part (e) is a back view.

FIG. 9 illustrates a header-side retaining fixture of the connector according to the exemplary embodiment of the present disclosure, in which part (a) is a first perspective view, part (b) is a second perspective view, part (c) is a third perspective view, and part (d) is a fourth perspective view.

FIG. 10 illustrates the header-side retaining fixture of the connector according to the exemplary embodiment of the present disclosure, in which part (a) is a first side view, part (b) is a plan view, part (c) is an underside view, (d) is a front view, (e) is a back view, (f) is a second side view.

FIG. 11 is a perspective view of a socket of the connector according to the exemplary embodiment of the present disclosure viewed from a front side.

FIG. 12 is a perspective view of the socket of the connector according to the exemplary embodiment of the present disclosure viewed from a back side.

FIG. 13 illustrates the socket of the connector according to the exemplary embodiment of the present disclosure, in which part (a) is a side view, part (b) is a plan view, part (c) is an underside view, and part (d) is a front view.

FIG. 14 is a perspective view of a socket housing of the connector according to the exemplary embodiment of the present disclosure viewed from a front side.

FIG. 15 is a perspective view of the socket housing of the connector according to the exemplary embodiment of the present disclosure viewed from a back side.

FIG. 16 illustrates the socket housing of the connector according to the exemplary embodiment of the present disclosure, in which part (a) is a side view, part (b) is a plan view, part (c) is an underside view, and part (d) is a front view.

FIG. 17 illustrates a first socket terminal of the connector according to the exemplary embodiment of the present disclosure, in which part (a) is a first perspective view, part (b) is a second perspective view, part (c) is a third perspective view, and part (d) is a fourth perspective view.

FIG. 18 illustrates the first socket terminal of the connector according to the exemplary embodiment of the present disclosure, in which part (a) is a side view, part (b) is a plan view, part (c) is an underside view, part (d) is a front view, and part (e) is a back view.

FIG. 19 illustrates a second socket terminal of the connector according to the exemplary embodiment of the present disclosure, in which part (a) is a first perspective view, part (b) is a second perspective view, part (c) is a third perspective view, and part (d) is a fourth perspective view.

FIG. 20 illustrates the second socket terminal of the connector according to the exemplary embodiment of the present disclosure, in which part (a) is a side view, part (b) is a plan view, part (c) is an underside view, part (d) is a front view, and part (e) is a back view.

FIG. 21 illustrates a socket-side retaining fixture of the connector according to the exemplary embodiment of the present disclosure, in which part (a) is a first perspective view, part (b) is a second perspective view, part (c) is a third perspective view, and part (d) is a fourth perspective view.

FIG. 22 illustrates the socket-side retaining fixture of the connector according to the exemplary embodiment of the present disclosure, in which part (a) is a back view, part (b) is a plan view, part (c) is an underside view, part (d) is a front view, part (e) is a first side view, part (f) is a second side view.

FIG. 23 is a cross-sectional view illustrating a state immediately before the header and the socket fit according to the exemplary embodiment of the present disclosure taken through a portion where the first header terminal and the first socket terminal are disposed.

FIG. 24 is a cross-sectional view illustrating a state of the header and the socket fitting each other according to the exemplary embodiment of the present disclosure taken through a portion where the first header terminal and the first socket terminal are disposed.

FIG. 25 is a cross-sectional view illustrating a state immediately before the header and the socket fit according to the exemplary embodiment of the present disclosure taken through a portion where the header-side retaining fixture and the second socket terminal are disposed.

FIG. 26 is a cross-sectional view illustrating a state of the header and the socket fitting each other according to the exemplary embodiment of the present disclosure taken through a portion where the header-side retaining fixture and the second socket terminal are disposed.

### DESCRIPTION OF EMBODIMENTS

An exemplary embodiment of the present disclosure will now be described in detail with reference to the attached drawings.

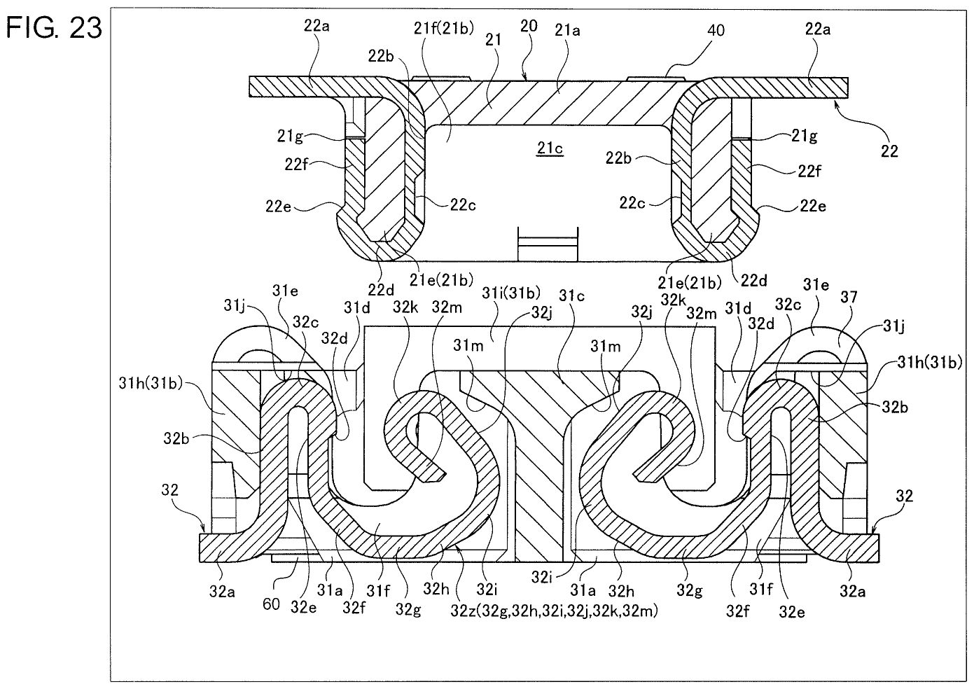

In the following description, a longitudinal direction of a connector (a header-side housing and a socket side housing) is defined as X direction, a width direction (short direction) of the connector (the header-side housing and the socket-side housing) is defined as Y direction, and a vertical direction of the connecter illustrated in FIG. 23 to FIG. 26 is defined as Z direction. Upper sides of the socket and the header in the state illustrated in FIG. 23 to FIG. 26 are defined as an upper side in the vertical direction (front side) and lower sides of the socket and the header in the state illustrated in FIG. 23 to FIG. 26 are defined as (back side) in the description.

With reference to FIG. 23 to FIG. 26, an outline of connector 10 according to the exemplary embodiment will be described.

Connector 10 according to the exemplary embodiment includes header (connector coupling body) 20 and socket (connector coupling body) 30 fitting each other as illustrated in FIG. 23 to FIG. 26. In the exemplary embodiment, header 20 includes header housing 21. In header housing 21, header-side signal terminals (first header terminals) 22 and header-side power source terminals (second header terminals) 23 are disposed. In contrast, socket 30 includes socket housing 31. In socket housing 31, socket-side signal terminals (first socket terminals) 32 and socket-side power source terminals (second socket terminals) 33 are disposed.

Fitting header housing 21 and socket housing 31 to each other brings header-side signal terminals 22 and socket-side signal terminals 32 into contact, and header-side power source terminals 23 and socket-side power source terminals 33 into contact.

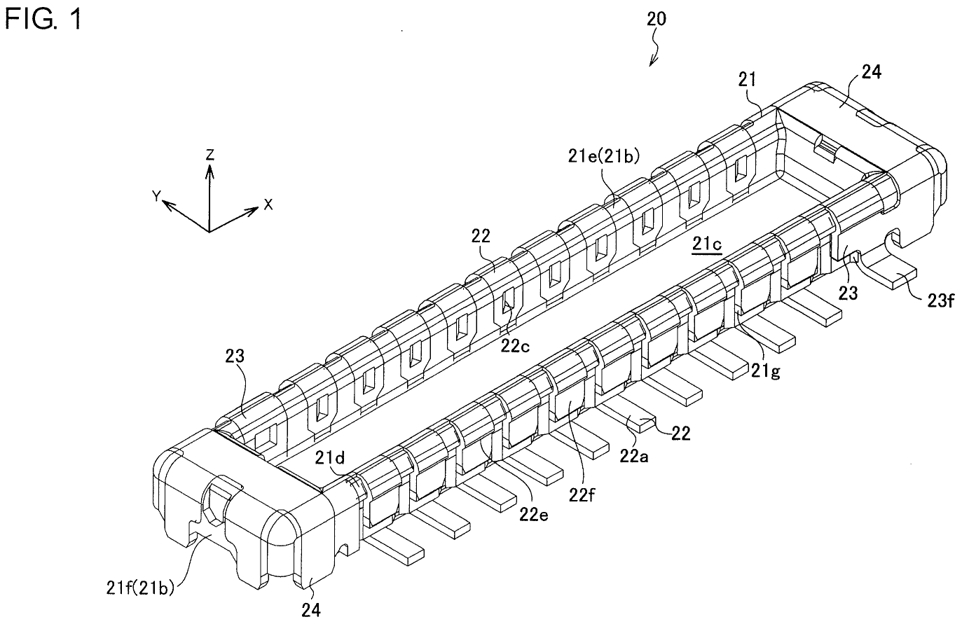

Header housing 21 is further provided with header-side retaining fixtures 24 (see FIG. 1), and socket housing 31 is provided with socket-side retaining fixtures 34.

Such header-side retaining fixture 24 is used for enhancing the strength of header housing 21 as well as for fixedly mounting a fixing portion of header-side retaining fixture 24 to second circuit board 40.

In contrast, socket-side retaining fixture 34 is used for enhancing the strength of socket housing 31 as well as for fixedly mounting a fixing portion of socket-side retaining fixtures 34 to first circuit board 60.

In the exemplary embodiment, header-side power source terminal 23 and header-side retaining fixture 24 are formed integrally to provide header-side retaining fixture 24 with a function as the header-side power source terminal. In contrast, socket-side retaining fixture 34 is formed as a separate member from socket-side power source terminals 33. In other words, socket-side retaining fixture 34 is provided separately from socket-side power source terminal 33.

Header-side power source terminal 23 and header-side retaining fixture 24 may be provided separately, and socket-side retaining fixture 34 and socket-side power source terminal 33 may be provided integrally.

Header 20 is configured to be mounted on second circuit board 40, and socket 30 is configured to be mounted on first circuit board 60.

Therefore, when header 20 and socket 30 are fitted each other, second circuit board 40 including header 20 and first circuit board 60 including socket 30 are electrically connected.

Specifically, by mounting header 20 according to the exemplary embodiment on second circuit board 40, header-side signal terminal 22 and header-side power source terminal 23 are electrically connected to a circuit pattern on second circuit board 40. Examples of second circuit board 40 include a Printed Circuit Board and a Flexible Printed Circuit (FPC).

By mounting socket 30 according to the exemplary embodiment on first circuit board 60, socket-side signal terminals 32 and socket-side power source terminals 33 are electrically connected to a circuit pattern on first circuit board 60. Examples of first circuit board 60 may also include a Printed Circuit Board and Flexible Printed Circuit (FPC).

Connector 10 according to the exemplary embodiment is also supposed to be used for electrically connecting circuit boards in electronic devices such as portable terminals like smart phones. However, connector 10 of the present disclosure may be used for electrically connecting any parts in the electronic device.

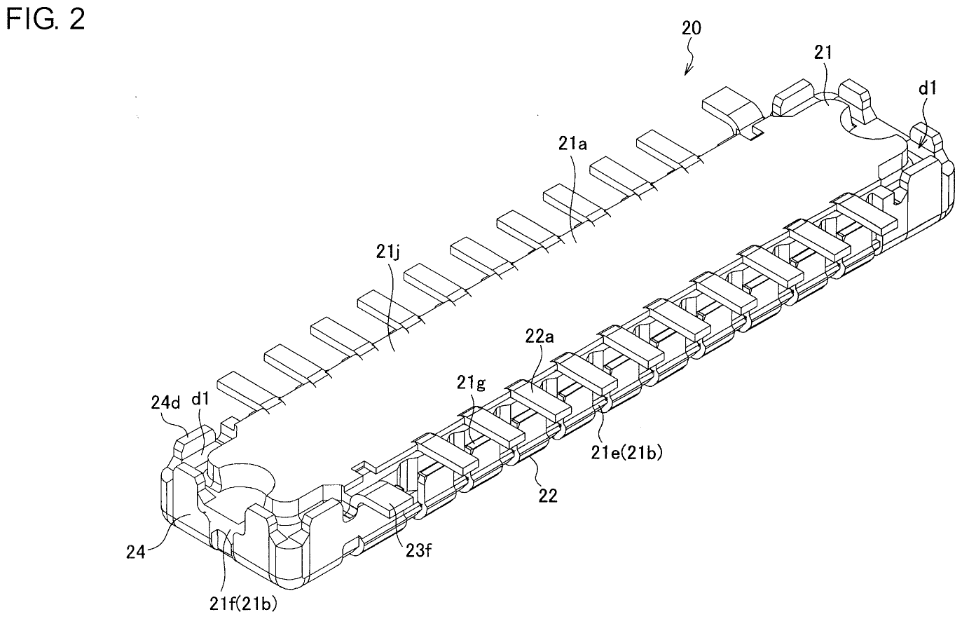

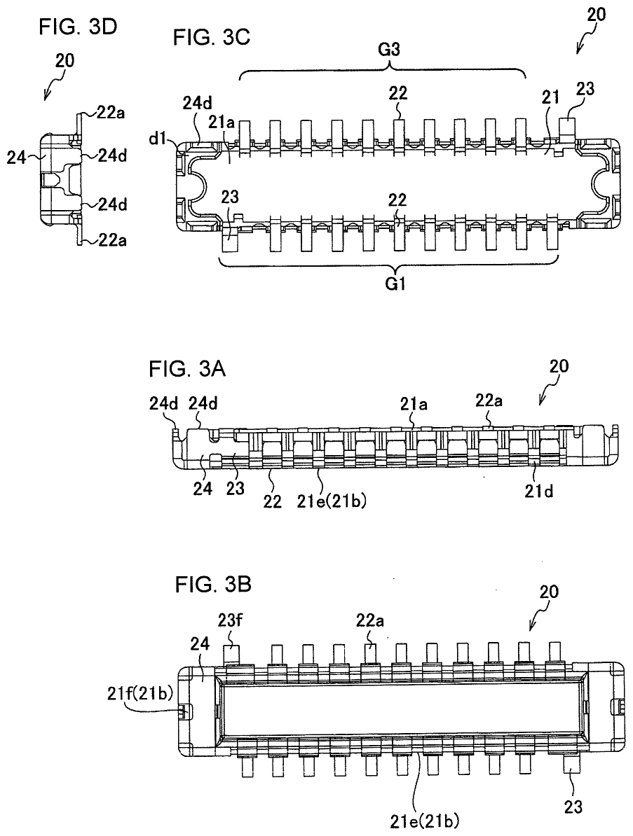

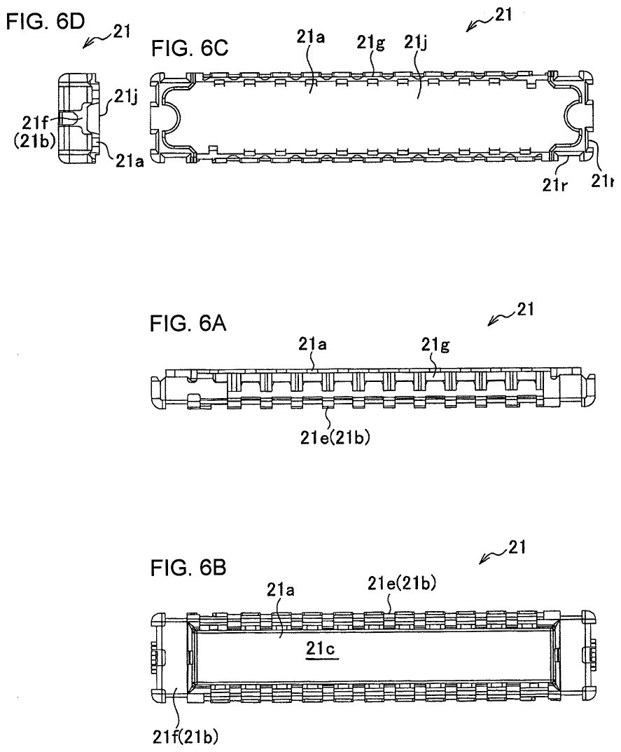

With reference to FIG. 1 to FIG. 10, a configuration of header 20 used in connector 10 will be described.

Header 20 includes header housing 21 as described above. Header housing 21 in the exemplary embodiment is formed of an insulative synthetic resin and is formed into a generally rectangular (oblong) shape in plan view (see FIG. 1 to FIG. 6).

Header housing 21 is provided with header-side signal terminals 22 formed of a metal, header-side power source terminals 23 formed of a metal, and header-side retaining fixtures 24 formed of a metal. Header-side signal terminals 22 are used for transmitting signals by being electrically connected to signal lines. In contrast, header-side power source terminals 23 are used for supplying power source by being electrically connected to power source lines. As described above, header-side retaining fixture 24 is formed integrally with header-side power source terminal 23. Therefore, in the exemplary embodiment, header-side retaining fixtures 24 are used for supplying power source by being electrically connected to power source lines and simultaneously, enhancing the strength of header housing 21.

In the exemplary embodiment, header-side signal terminals 22 and header-side power source terminals 23 are arranged in rows along longitudinal direction X of header housing 21.

Specifically, a plurality of header-side signal terminals 22 are arranged in a line along one of longitudinal sides of header housing 21 at predetermined pitches. The plurality of header-side signal terminals 22 arranged in a line on header housing 21 on one side in width direction (short direction) Y constitute a header-side signal terminal group (first header terminal group) G3.

In addition, one header-side power source terminal 23 is arranged in a line with one header-side signal terminal group G3 along the one of longitudinal sides of header housing 21 at a distance. One header-side signal terminal group G3 and one header-side power source terminal 23 arranged in a line on header housing 21 on the one side in width direction (short direction) Y constitute one header side terminal group G1.

Likewise, the plurality of header-side signal terminals 22 are arranged in a line also along the other longitudinal side of header housing 21 at predetermined pitches. The plurality of header-side signal terminals 22 arranged in a line on header housing 21 on the other side in width direction (short direction) Y constitute other header-side signal terminal group G3.

In addition, one header-side power source terminal 23 is arranged in a line with one header-side signal terminal group G3 along the other longitudinal side of header housing 21 at a distance. One header-side signal terminal group G3 and one header-side power source terminal 23 arranged in a line in header housing 21 on other side in width direction (short direction) Y constitute header side terminal group G1.

In this manner, in the exemplary embodiment, header housing 21 includes two (a plurality of) rows of header-side terminal groups G1 each including header-side signal terminal group G3 and header-side power source terminal 23 arranged along longitudinal direction X of header housing 21.

In the exemplary embodiment, one header-side terminal group G1 formed on one side in width direction (short direction) Y of header housing 21 includes one header-side power source terminal 23 arranged on one side in longitudinal direction X of header housing 21. Likewise, other header-side terminal group G1 formed on header housing 21 on other side in width direction (short direction) Y includes other header-side power source terminal 23 arranged on other side in longitudinal direction X of header housing 21.

In this manner, in the exemplary embodiment, header-side power source terminals 23 are disposed at two positions, that is, at a position on the one side in longitudinal direction X and on the one side in width direction (short direction) Y of header housing 21, and at a position on the other side in longitudinal direction X and on other side in width direction (short direction) Y of header housing 21.

In other words, header housing 21 includes only two pieces of header-side power source terminals 23, and two pieces of header-side power source terminals 23 are arranged at opposing corners of header housing 21 having a rectangular (oblong) shape.

Two header-side power source terminals 23 are arranged on header housing 21 in a state to position header-side retaining fixtures 24 at both ends in longitudinal direction X of header housing 21 (header-side retaining fixtures 24 are located on both outer sides of header-side power source terminals 23 in longitudinal direction X of header housing 21).

Furthermore, in the exemplary embodiment, one header-side signal terminal group G3 on the one longitudinal side and other header-side signal terminal group G3 on the other longitudinal side are formed at positions shifted from each other in longitudinal direction X of header housing 21.

Specifically, header-side signal terminals 22 are arranged to form one header-side signal terminal group G3 at a position shifted from other header-side signal terminal group G3 in longitudinal direction X of header housing 21 by a distance corresponding to one pitch.

In this configuration, header-side signal terminals 22 on both sides in Y direction may be arranged to oppose each other in Y direction except for header-side signal terminal 22 arranged at one end in X direction of one header-side signal terminal group G3 and header-side signal terminal 22 arranged at one end of in X direction of other header-side signal terminal group G3.

In the exemplary embodiment, header-side power source terminal 23 constituting other header-side signal terminal group G1 is arranged to be aligned in Y direction with header-side signal terminal 22 arranged at the other end in X direction of one header-side signal terminal group G3.

Likewise, header-side power source terminal 23 constituting one header-side signal terminal group G1 is arranged to be aligned in Y direction with header-side signal terminal 22 arranged at the other end in X direction of other header-side signal terminal group G3.

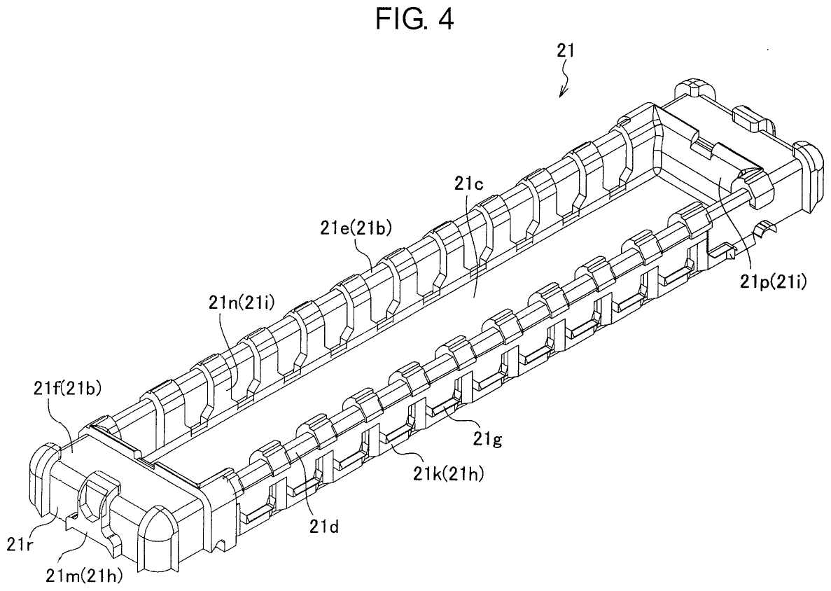

With reference to FIG. 4 to FIG. 6, a configuration of header housing 21 will be described.

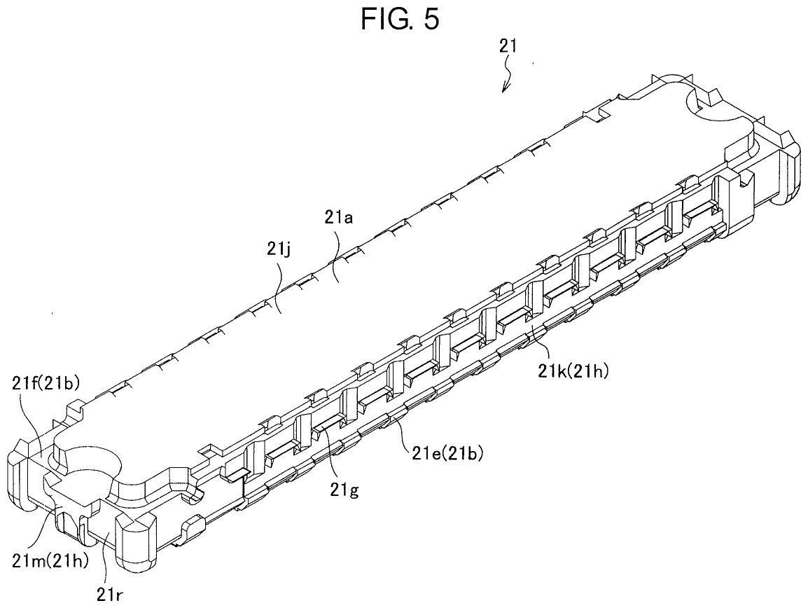

Header housing 21 includes plate-shaped wall portion 21a and peripheral wall portion 21b formed continuously along a peripheral edge portion of plate-shaped wall portion 21a into a substantially rectangular ring shape. Header housing 21 is formed into a substantially box shape opening on one side (the lower side in FIG. 5).

Peripheral wall portion 21b defines depression 21c (see FIG. 4) inside. Peripheral wall portion 21b includes tapered portion 21d on a lower end on an outer peripheral side. Tapered portion 21d inclines upward (toward plate-shaped wall portion 21a) as it goes outward.

Parts of peripheral wall portion 21b between adjacent header-side signal terminals 22 and between header-side signal terminal group G3 and header-side power source terminal 23 have R shape (inverted U-shape).

In the exemplary embodiment, peripheral wall portion 21b includes a pair of longitudinal wall portions 21e opposing each other in width direction (short direction) Y and a pair of short direction wall portions 21f facing opposing each other in longitudinal direction X.

Short direction wall portions 21f are formed to have substantially the same length in width direction Y as a distance between opposing two longitudinal wall portions 21e (a distance from an outer surface 21k of one of the pair of longitudinal wall portions 21e to an outer surface 21k of the other one of the pair of longitudinal wall portions 21e). Longitudinal wall portions 21e are formed to have substantially the same length in longitudinal direction X as a distance between opposing two short direction wall portions 21f (a distance from an outer surface 21m of one of the pair of short direction wall portions 21f to an outer surface 21m of the other one of the pair of short direction wall portions 210.

In this manner, in the exemplary embodiment, header housing 21 is formed generally into a substantially rectangular shape in plan view. Therefore, outer surfaces 21k of longitudinal wall portions 21e and outer surfaces 21m of short direction wall portions 21f correspond to an outer surface 21h of peripheral wall portion 21b, and inner surfaces 21n of longitudinal wall portions 21e and inner surfaces 21p of short direction wall portions 21f correspond to an inner surface 21i of peripheral wall portion 21b.

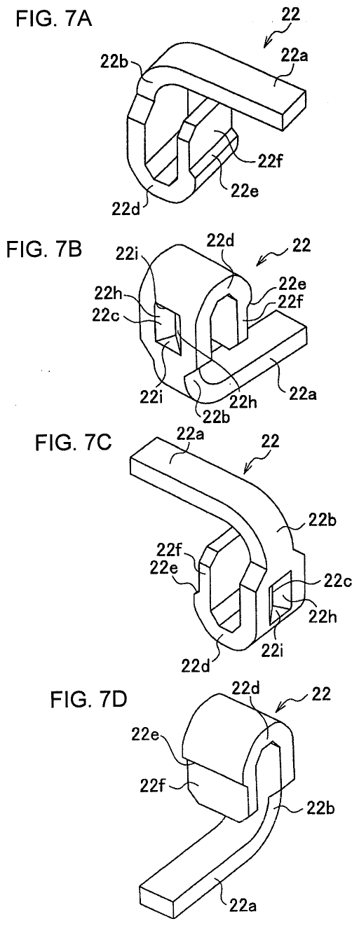

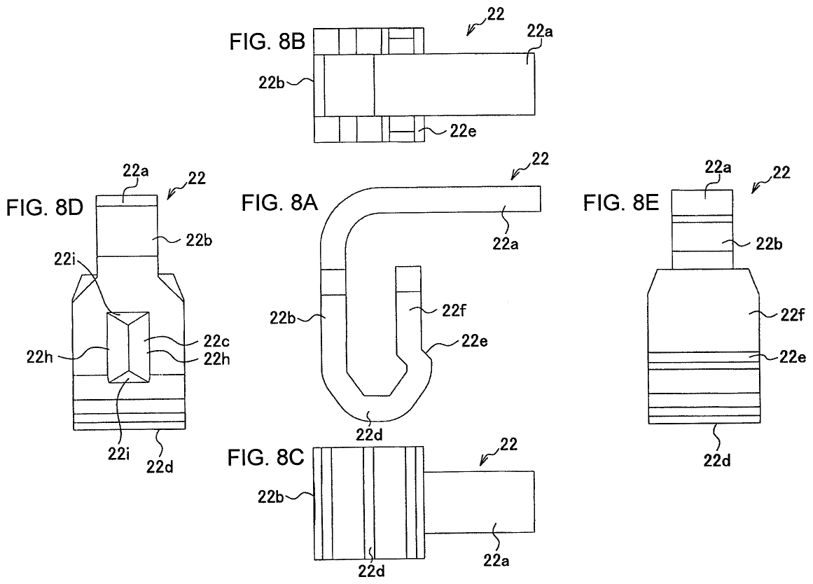

With reference next to FIG. 7 and FIG. 8, a configuration of header-side signal terminal 22 will be described.

Header-side signal terminal 22 is manufactured by metal molding and is an electrical conductor. Header-side signal terminal 22 includes root portion (first header-terminal-side fixed portion) 22a protruding from a side surface of header housing 21. Root portion 22a is to be fixed to the circuit pattern of second circuit board 40 by soldering. An upper surface of root portion 22a extends in substantially parallel to an upper surface (outer surface 21j of plate-shaped wall portion 21a) of header housing 21 as is seen in FIG. 23.

Header-side signal terminal 22 also includes an inner portion 22b continuing to root portion 22a. Inner portion 22b penetrates through a joint portion between plate-shaped wall portion 21a and longitudinal wall portions 21e of header housing 21 while being bent and extends along inner surface 21n of longitudinal wall portion 21e to a distal end portion of longitudinal wall portion 21e.

Inner portion 22b of header-side signal terminal 22 includes depression 22c on an inner surface. In the exemplary embodiment, depression 22c includes inclined surfaces 22h continuing to both sides in longitudinal direction X and inclined surfaces 22i continuing to both sides in vertical direction Z, and thus is formed into a substantially triangular prism shape. Depression 22c receives an arcuate-shaped projection 32k of socket-side signal terminal 32 described later.

Header-side signal terminal 22 further includes distal end portion 22d continuing to one end of inner portion 22b. Distal end portion 22d is bent in conformance with the shape of distal end of longitudinal wall portion 21e of header housing 21.

Header-side signal terminal 22 is provided with engaged portion 22e continuing to distal end portion 22d. Engaged portion 22e in the exemplary embodiment is formed from one end to the other end of header housing 21 in longitudinal direction X of header housing 21 of header-side signal terminal 22. In other words, engaged portion 22e is formed along the entire width of header-side signal terminal 22 in a shoulder shape.

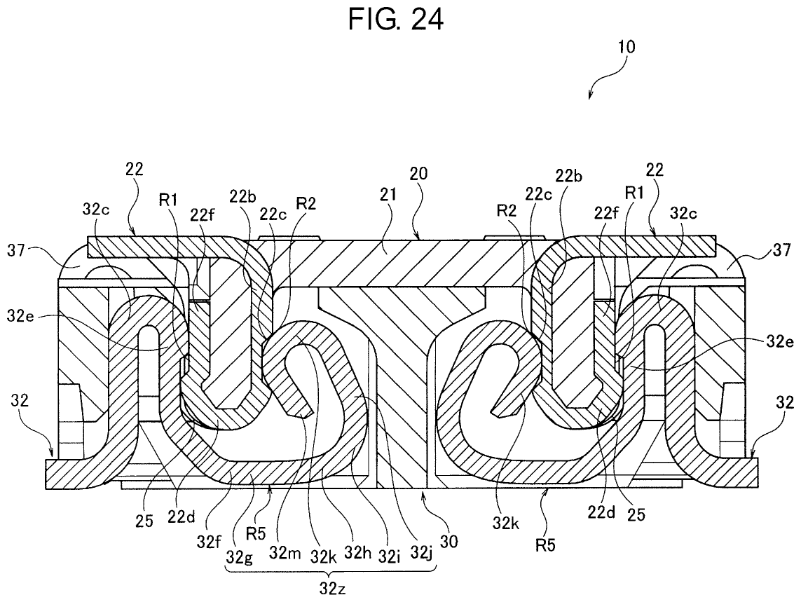

When header-side signal terminal 22 is fitted in socket-side signal terminal 32, engaged portion 22e is inserted further inward with respect to engaging portion 32d formed into a shouldered portion as is understood by comparing FIG. 23 and FIG. 24. Therefore, engaged portion 22e abuts engaging portion 32d when header-side signal terminal 22 is pulled out from socket-side signal terminal 32. In other words, engaged portion 22e of header-side signal terminal 22 is engaged by engaging portion 32d of socket-side signal terminal 32. Therefore, unintentional detachment of header-side signal terminal 22 from socket-side signal terminal 32 may be prevented or reduced. In other words, header-side signal terminal 22 cannot be pulled out from socket-side signal terminal 32 with an external force smaller than a predetermined value. In contrast, header-side signal terminal 22 may be pulled out from socket-side signal terminal 32 with an external force larger than the predetermined value. In other words, engaged portion 22e of header-side signal terminal 22 and engaging portion 32d of socket-side signal terminal 32 constitute a lock mechanism configured to allow disengagement by application of the external force larger than the predetermined value.

Engaged portion 22e may be formed by rolling to partly differentiate the thickness of header-side signal terminal 22 and, alternatively, may be formed by bending the base material of header-side signal terminal 22 in a thickness direction.

In addition, header-side signal terminal 22 includes outer portion 22f continuing to distal end portion 22d via engaged portion 22e and extending along outer surface 21k of longitudinal wall portion 21e. In the exemplary embodiment, positioning of distal ends of outer portions 22f of header-side signal terminals 22 is achieved by protruding wall portions 21g protruding from the outer periphery of longitudinal wall portions 21e (peripheral wall portion 21b).

Header-side signal terminals 22 having such configuration may be formed by curving band-shaped metallic materials having a predetermined thickness.

In the exemplary embodiment, header-side signal terminals 22 may be disposed in header housing 21 by insert molding. Header-side signal terminals 22 may be disposed in header housing 21 by press fitting header-side signal terminals 22 into header housing 21.

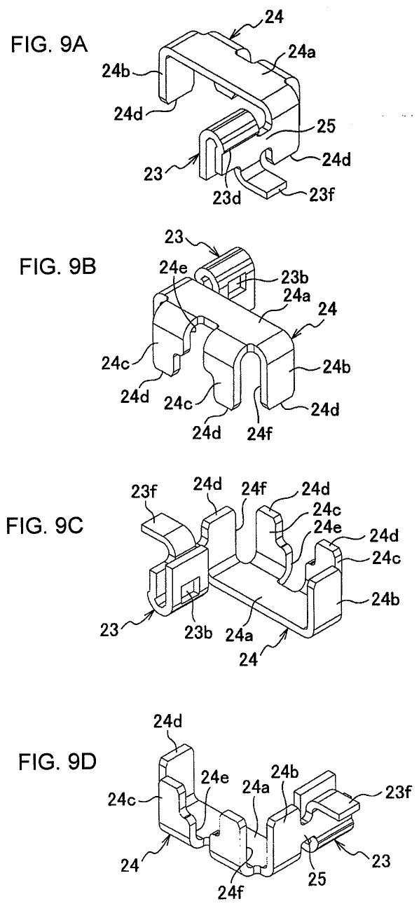

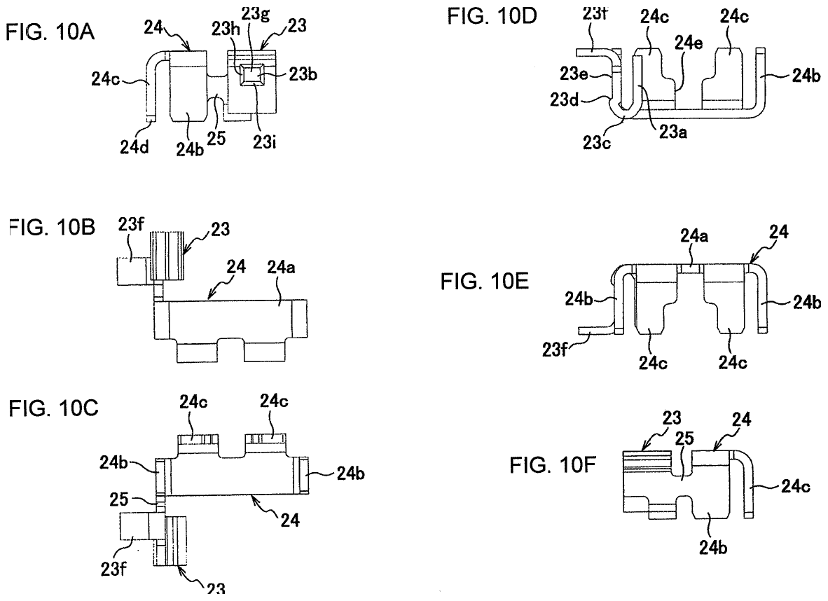

With reference next to FIG. 9 and FIG. 10, configurations of header-side power source terminal 23 and header-side retaining fixture 24 will be described.

Header-side power source terminal 23 is manufactured by metal molding and is an electrical conductor. Header-side power source terminal 23 includes inner portion 23a disposed to extend in conformance with an inner surface of header housing 21. Inner portion 23a extends from the joint portion between plate-shaped wall portion 21a and longitudinal wall portion 21e of header housing 21 along inner surface 21n of longitudinal wall portion 21e to a distal end portion of longitudinal wall portion 21e.

Inner portion 23a of header-side power source terminal 23 includes a depression 23b on an inner surface. In the exemplary embodiment, depression 23b includes inner bottom surface 23g having a flat shape, inclined surfaces 23h formed continuously from both sides of inner bottom surface 23g in longitudinal direction X, and inclined surfaces 23i formed continuously on both sides of inner bottom surface 23g in vertical direction Z. Depression 23b is formed generally into a substantially truncated pyramid shape. Depression 23b receives an arcuate-shaped projection 33k of socket-side power source terminal 33 described later.

Header-side power source terminal 23 is further provided with distal end portion 23c continued to one end of inner portion 23a. Distal end portion 23c is bent in conformance with the shape of the distal end of longitudinal wall portion 21e of header housing 21.

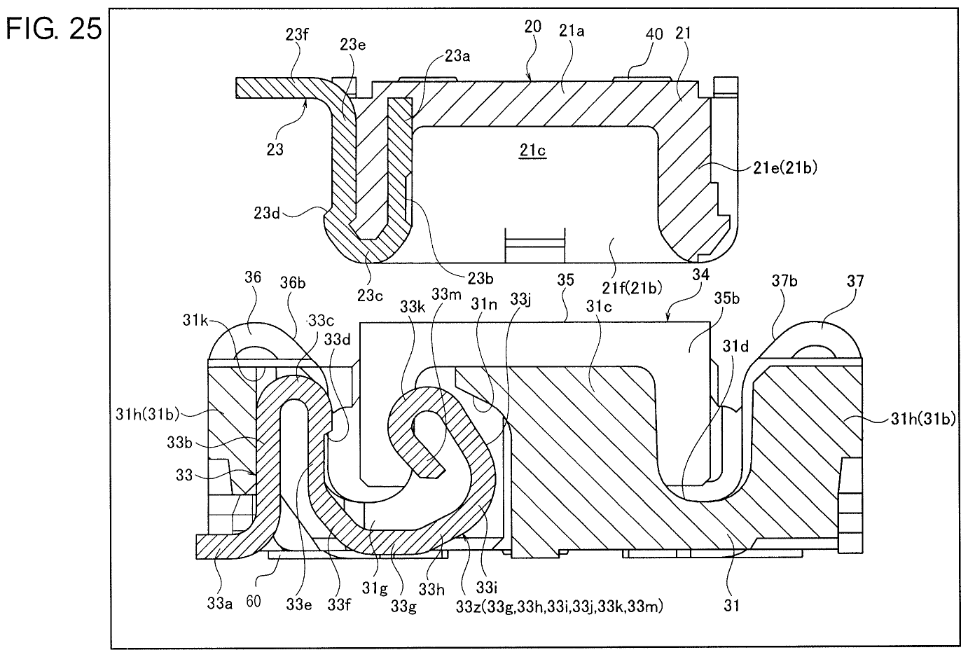

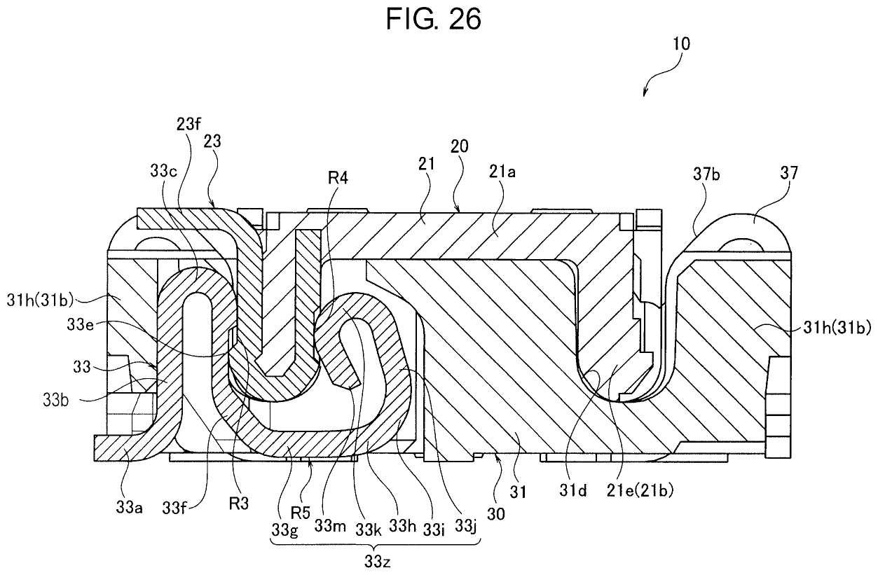

Header-side power source terminal 23 is provided with engaged portion 23d continuing to distal end portion 23c. When header-side power source terminal 23 is fitted in socket-side power source terminal 33, engaged portion 23d is inserted further inward with respect to an engaging portion 33d formed into a shouldered portion as is understood by comparing FIG. 25 and FIG. 26. Therefore, engaged portion 23d abuts engaging portion 33d when header-side power source terminal 23 is pulled out from socket-side power source terminal 33. In other words, engaged portion 23d of header-side power source terminal 23 is engaged by engaging portion 33d of socket-side power source terminal 33. Therefore, unintentional detachment of header-side power source terminal 23 from socket-side power source terminal 33 may be prevented or reduced. In other words, header-side power source terminal 23 cannot be pulled out from socket-side power source terminal 33 with an external force smaller than a predetermined value. In contrast, header-side power source terminal 23 may be pulled out from socket-side power source terminal 33 with an external force larger than the predetermined value. In other words, engaged portion 23d of header-side power source terminal 23 and engaging portion 33d of socket-side power source terminal 33 constitute a lock mechanism configured to allow disengagement by application of the external force larger than the predetermined value.

Engaged portion 23d may be formed by rolling to partly differentiating the thickness of header-side power source terminal 23 and, alternatively, may be formed by bending the base material of header-side power source terminal 23 in a thickness direction.

Header-side power source terminal 23 also includes outer portion 23e continuing to engaged portion 23d and disposed to extend in conformance with an outer surface of header housing 21. Outer portion 23e extends from engaged portion 23d to plate-shaped wall portion 21a along outer surface 21k of longitudinal wall portion 21e.

Header-side power source terminal 23 includes root portion (second header-terminal-side fixed portion) 23f continuing to outer portion 23e and protruding from a side surface of header housing 21. Root portion 23f is a portion to be fixed to the circuit pattern of second circuit board 40 by soldering. An upper surface of root portion 23f extends in substantially parallel to an upper surface (an outer surface 21j of plate-shaped wall portion 21a) of header housing 21 as is seen in FIG. 25.

In the exemplary embodiment, root portion 23f is formed to have a width along longitudinal direction X of header housing 21 smaller than a width along longitudinal direction X of outer portion 23e (other portions of header-side power source terminals 23). Root portion 23f continues to an outside portion of outer portion 23e in longitudinal direction X (the side farther from header-side signal terminal 22 adjacent in X direction).

In other words, with header-side signal terminal 22 and header-side power source terminal 23 disposed in header housing 21, the distance between root portion (first header-terminal-side fixed portion) 22a and root portion (second header-terminal-side fixed portion) 23f is larger than a distance between contact portions (first socket-terminal-side contact portions) R1 and R2 of the header-side signal terminal 22 and contact portions (second header-terminal-side fixed portion) R3 and R4 of the header-side power source terminal 23, described later.

In this configuration, an insulation distance between header-side power source terminal 23 and header-side signal terminal 22 is increased to secure insulation properties.

As described above, header-side signal terminal 22 and header-side power source terminal 23 are disposed along longitudinal direction X of header housing 21. In the exemplary embodiment, header-side power source terminal 23 is formed to have a width along longitudinal direction X of header housing 21 larger than a width of header-side signal terminal 22 along longitudinal direction X.

In other words, in the exemplary embodiment, header-side signal terminal 22 has a smaller width than header-side power source terminal 23 in longitudinal direction X of header housing 21. Note that, in the exemplary embodiment all header-side signal terminals 22 have a smaller width than header-side power source terminal 23 in the longitudinal direction X of header housing 21.

Furthermore, engaged portion 23d in the exemplary embodiment is formed from one end to the other end of header housing 21 of header-side power source terminal 23 in longitudinal direction X of header housing 21. In other words, engaged portion 23d having a shoulder shape is formed along an entire width of header-side power source terminal 23 having a wide width. In this configuration, an improved locking force is provided by engaged portion 23d of header-side power source terminal 23 and engaging portion 33d of socket-side power source terminal 33. In addition, abrasion of engaged portion 23d by repeated insertion and withdrawal of header 20 and socket 30 is reduced, and thus longer lifetime of a product is achieved.

In the exemplary embodiment, header-side power source terminal 23 may be disposed on header housing 21 by insert molding. Header-side power source terminal 23 may be disposed on header housing 21 by press fitting header-side power source terminal 23 into header housing 21.

Header-side retaining fixture 24 is fixed to header-side power source terminal 23 via joint portion 25.

Header-side retaining fixture 24 is manufactured by metal molding like header-side signal terminal 22 and header-side power source terminal 23 and is an electrical conductor.

An integrated member consisting of header-side power source terminal 23 and header-side retaining fixture 24 may be formed by bending a metallic plate having a predetermined thickness.

Header-side retaining fixture 24 includes lower wall portion 24a having a substantially rectangular plate shape and disposed to cover a distal end (lower end) of short direction wall portions 21f substantially entirely.

Header-side retaining fixture 24 includes a pair of first side wall portions 24b extending from both ends of lower wall portion 24a in width direction (short direction) Y toward plate-shaped wall portion 21a.

First side wall portions 24b extend in conformance with outer surfaces 21k of longitudinal wall portion 21e and are formed to have distal ends protruding slightly beyond an outer surface 21j of plate-shaped wall portion 21a. The distal ends of first side wall portions 24b correspond to fixed portions 24d to be fixed to the circuit pattern of second circuit board 40 by soldering.

In addition, joint portion 25 continues to one of the pair of first side wall portions 24b. In the exemplary embodiment, one end (outside in longitudinal direction X) of joint portion 25 continues to a center portion of one of first side wall portions 24b in vertical direction Z, while the other end (inside in the longitudinal direction X) of joint portion 25 continues to outer portion 23e of header-side power source terminal 23.

Header-side retaining fixture 24 also includes a pair of side strips (second side wall portions) 24c extending from one end (outside) of lower wall portion 24a extending in longitudinal direction X toward plate-shaped wall portion 21a. Side strips 24c extends in conformance with outer surface 21m of short direction wall portions 21f, and are formed to have distal ends protruding slightly beyond outer surface 21j of plate-shaped wall portion 21a. Distal ends of side strips 24c also correspond to fixed portions 24d to be fixed to the circuit pattern of second circuit board 40 by soldering.

In this manner, in the exemplary embodiment, header-side retaining fixture 24 is fixed to circuit pattern of second circuit board 40 by four of fixed portions 24d and thus includes four fixed points in three directions (one end in the longitudinal direction X and both ends in width direction Y). Note that the integrated member consisting of header-side power source terminal 23 and header-side retaining fixture 24 is fixed to the circuit pattern of second circuit board 40 at four fixed portions 24d and root portion 22a.

A gap d1 is formed between fixed portions (four fixed portions 24d and root portion 23f) and header housing 21. Gap d1 functions as a run-out for solder when the fixed portions are soldered, or functions as a heat-releasing portion to avoid an excessive temperature increase of header housing 21.

In the exemplary embodiment, the pair of side strips 24c extend from both ends of lower wall portion 24a in width direction (short direction) Y, and gap 24e having a cutout shape is formed between the pair of side strips 24c (center portion in width direction Y).

Furthermore, in the exemplary embodiment, gap 24f having a cutout shape is also formed between first side wall portions 24b and side strips 24c (at a corner of header housing 21).

Header-side power source terminal 23 and header-side retaining fixture 24 are attached to header housing 21 in a state of being embedded into an engaging groove portions 21r formed at both end portions of header housing 21 in longitudinal direction X of header housing 21 by insert molding.

At this time, resin enters gaps 24e and 24f having a cutout shape and a gap between header-side power source terminal 23 and header-side retaining fixture 24. In this configuration, a fixing strength of header-side power source terminal 23 and header-side retaining fixture 24 to header housing 21 is enhanced.

The integrated member composed of header-side power source terminal 23 and header-side retaining fixture 24 is disposed in header housing 21 by insert molding in the exemplary embodiment. However, the integrated member may be disposed in header housing 21 by press-fitting.

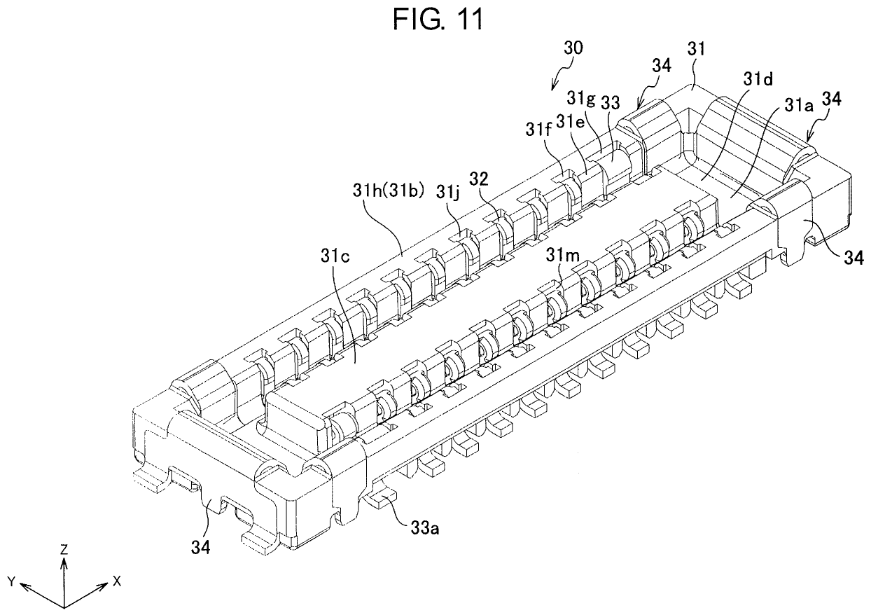

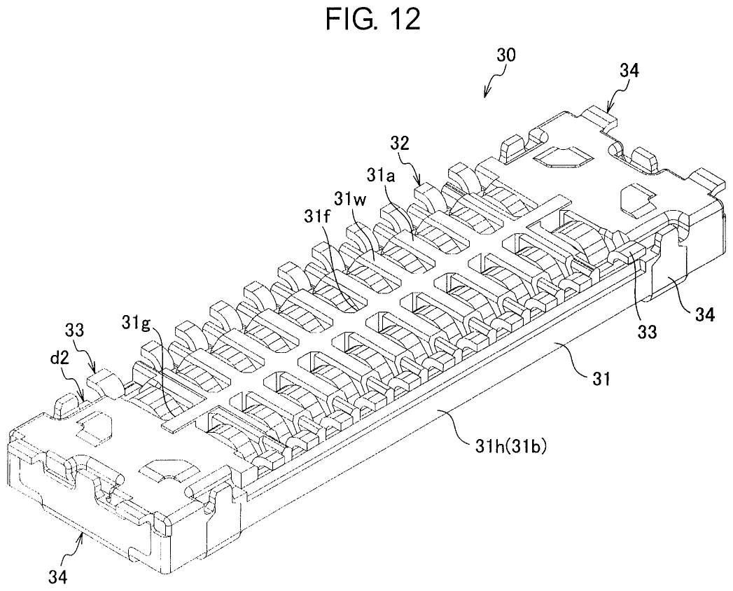

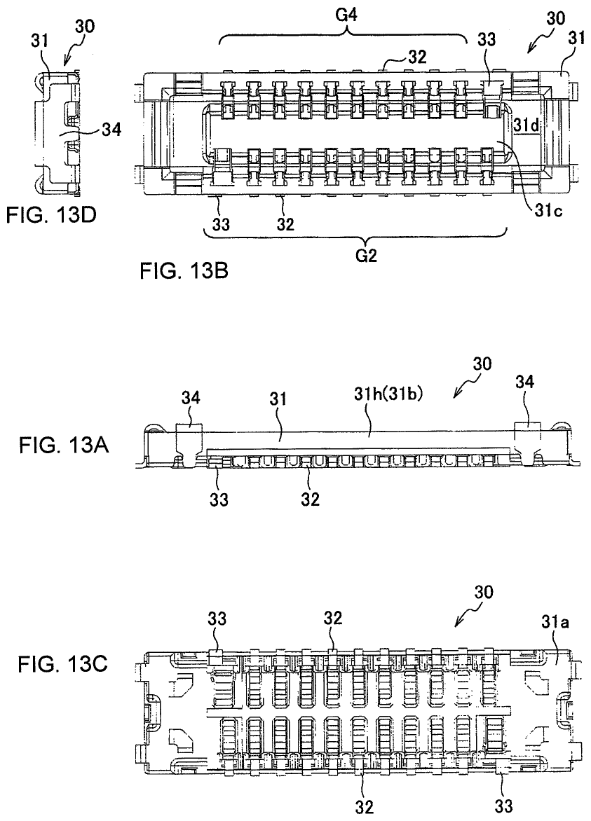

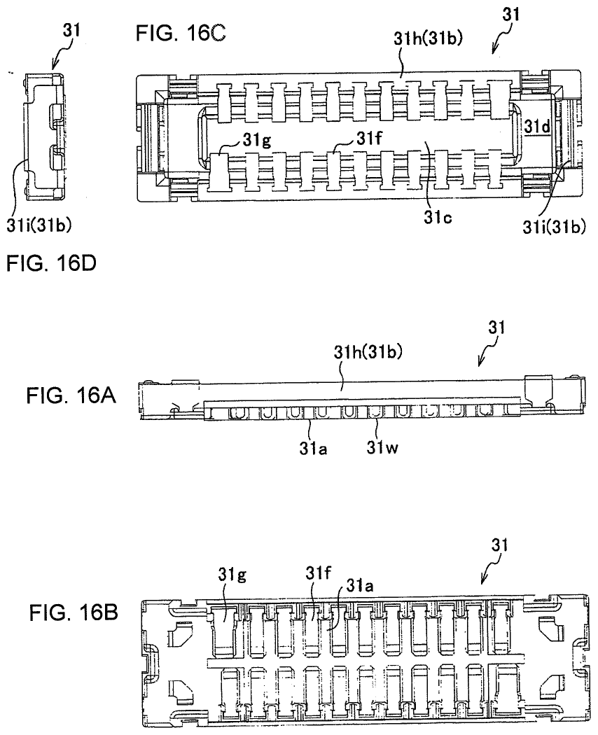

With reference next to FIG. 11 to FIG. 22, a configuration of socket 30 used in connector 10 will be described.

Socket 30 is provided with socket housings 31 as described above. Socket housing 31 in the exemplary embodiment is formed of an insulative synthetic resin and is formed into a generally rectangular (oblong) shape in plan view (see FIG. 11 to FIG. 16).

Socket-side signal terminals 32 formed of a metal and socket-side power source terminals 33 formed of a metal are disposed in socket housing 31. Socket-side signal terminals 32 are used for transmitting signals by being electrically connected to signal lines. In contrast, socket-side power source terminals 33 are used for supplying power source by being electrically connected to power source lines.

Furthermore, in the exemplary embodiment, socket-side signal terminals 32 and socket-side power source terminals 33 are arranged in rows along longitudinal direction X of socket housing 31.

Specifically, a plurality of socket-side signal terminals 32 are arranged in a line along one of longitudinal sides of socket housing 31 at predetermined pitches. The plurality of socket-side signal terminals 32 arranged in a line on one side in width direction (short direction) Y of socket housing 31 constitute socket-side signal terminal group (first socket terminal group) G4.

In addition, one socket-side power source terminal 33 is arranged in a line with one socket-side signal terminal group G4 along one longitudinal side of socket housing 31 at a distance. One socket-side signal terminal group G4 and one socket-side power source terminal 33 arranged in a line on one side in width direction (short direction) Y of socket housing 31 constitute one socket-side signal terminal group G2.

The plurality of socket-side signal terminals 32 are also arranged in a line along other longitudinal side of socket housing 31 at predetermined pitches. The plurality of socket-side signal terminals 32 arranged in a line arranged on other side in width direction (short direction) Y of socket housing 31 constitute other socket-side signal terminal group G4.

In addition, one socket-side power source terminal 33 is arranged in a line with one socket-side signal terminal group G4 along the other longitudinal side of socket housing 31 at a distance. Other socket-side signal terminal group G4 and one socket-side power source terminal 33 arranged in a line on socket housing 31 on other side in width direction (short direction) Y of socket housing 31 constitute other socket-side signal terminal group G2.

In this manner, in the exemplary embodiment, socket housing 31 includes two (a plurality of) rows of socket-side signal terminal groups G2 each including socket-side signal terminal group G4 and socket-side power source terminal 33 arranged along longitudinal direction X of socket housing 31.

In the exemplary embodiment, one socket-side signal terminal group G2 formed on the one side in width direction (short direction) Y of socket housing 31 includes one socket-side power source terminal 33 arranged on one side in longitudinal direction X of socket housing 31. Likewise, other socket-side signal terminal group G2 formed on the other side in width direction (short direction) Y of socket housing 31 includes other socket-side power source terminals 33 arranged on the other side of the socket housing 31 in the longitudinal direction X.

In this manner, in the exemplary embodiment, socket-side power source terminals 33 are disposed at two positions, that is, at a position on one side in longitudinal direction X of socket housing 31 and one side in width direction (short direction) Y and at a position on the other side in longitudinal direction X and on other side in width direction (short direction) Y of socket housing 31.

In other words, socket housing 31 includes only two pieces of socket-side power source terminals 33, and the two pieces of socket-side power source terminals 33 are arranged at opposing corners of socket housing 31 having a rectangular (oblong) shape.

Furthermore, in the exemplary embodiment, one socket-side signal terminal group G4 on the one longitudinal side and other socket-side signal terminal group G4 on the other longitudinal side are formed at positions shifted from each other in longitudinal direction X of socket housing 31.

Specifically, socket-side signal terminals 32 are arranged to form one socket-side signal terminal group G4 at a position shifted from other socket-side signal terminal group G4 in longitudinal direction X of socket housing 31 by a distance corresponding to one pitch.

In this configuration, socket-side signal terminals 32 on both sides in Y direction may be arranged to oppose each other in Y direction except for socket-side signal terminal 32 arranged at one end in X direction of one socket-side signal terminal group G4 and socket-side signal terminal 32 arranged at the other end in X direction of other socket-side signal terminal group G4.

In the exemplary embodiment, other socket-side power source terminal 33 constituting other socket-side signal terminal group G2 is arranged to be aligned in Y direction with socket-side signal terminal 32 arranged at one end in X direction of one socket-side signal terminal group G4.

Likewise, one socket-side power source terminal 33 constituting socket-side signal terminal group G2 is arranged to be aligned in Y direction with other socket-side signal terminal 32 arranged at the other end in X direction of other socket-side signal terminal group G4.

Note that socket-side signal terminal 32 and socket-side power source terminals 33 are disposed on socket housing 31 in such a way as to contact respectively with corresponding header-side signal terminals 22 and header-side power source terminals 23 when header 20 fits socket 30.

In addition, in the exemplary embodiment, socket-side retaining fixtures 34 formed of a metal are disposed at both ends in longitudinal direction X of socket housing 31 (outer sides of socket-side signal terminal groups G2 in longitudinal direction X). Socket-side retaining fixtures 34 are used for enhancing the strength of socket housing 31 as well as for fixedly mounting fixing portions of socket-side retaining fixtures 34 to first circuit board 60 described above.

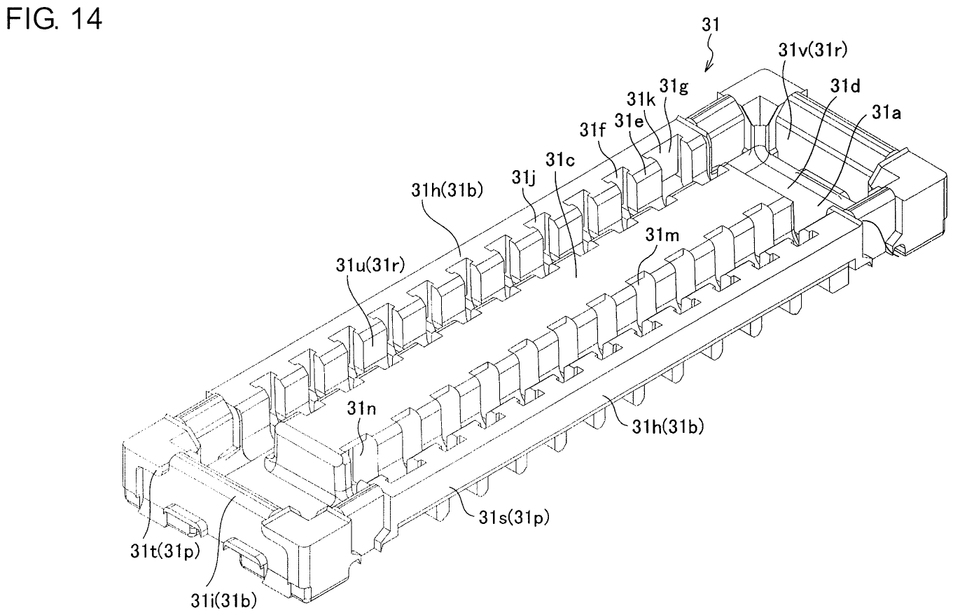

With reference next to FIG. 14 to FIG. 16, a configuration of socket housing 31 will be described.

Socket housing 31 includes plate-shaped wall portion 31a and peripheral wall portion 31b formed continuously along a peripheral edge portion of plate-shaped wall portion 31a into a substantially rectangular ring shape. Socket housing 31 is formed into a substantially box shape opening on one side (the upper side in FIG. 14). In addition, in the exemplary embodiment, an island portion 31c having a substantially rectangular shape is formed at a center portion of plate-shaped wall portion 31a at a predetermined distance from peripheral wall portion 31b. Formed between peripheral wall portion 31b and island portion 31c is fitting groove portion 31d having a substantially frame shape for fitting peripheral wall portion 21b of header 20.

Island portion 31c is fitted in depression 21c.

Since short direction wall portions 21f and longitudinal wall portion 21e are fitted into fitting groove portion 31d, a width of fitting groove portion 31d is slightly wider at both end portions in short direction Y.

Furthermore, in the exemplary embodiment, peripheral wall portion 31b is provided with tapered portions 31e on an upper end on an inner peripheral side. Tapered portions 31e incline downward (toward plate-shaped wall portion 31a) as they go inward. Tapered portions 31e are formed at both ends in the longitudinal direction of longitudinal wall portions 31h of peripheral wall portion 31b and on short direction wall portions 31i of peripheral wall portion 31b.

Tapered portions 31e are also formed on peripheral wall portion 31b between socket-side signal terminals 32 and socket-side power source terminals 33 adjacent to each other. Tapered portions 31e are also formed on peripheral wall portion 31b between socket-side power source terminals 33 and socket-side retaining fixtures 34. In this manner, in the exemplary embodiment, tapered portions 31e are formed substantially entirely over the periphery of peripheral wall portion 31b.

In the exemplary embodiment, peripheral wall portion 31b includes a pair of longitudinal wall portions 31h opposing each other in width direction (short direction) Y and a pair of short direction wall portions 31i facing opposing each other in longitudinal direction X.

Short direction wall portions 31i are formed to have substantially the same length in width direction Y as a distance between opposing two longitudinal wall portions 31h (a distance from an outer surface 31s of one of the pair of longitudinal wall portions 31h to an outer surface 31s of the other one of the pair of longitudinal wall portions 31h). Longitudinal wall portions 31h are formed to have substantially the same length in longitudinal direction X as a distance between opposing two short direction wall portions 31i (a distance from an outer surface 31t of one of a pair of short direction wall portions 31i to an outer surface 31t of the other one of the pair of short direction wall portions 31i).

In this manner, in the exemplary embodiment, socket housing 31 is formed generally into a substantially rectangular shape in plan view. Therefore, outer surfaces 31s of longitudinal wall portions 31h and outer surfaces 31t of short side wall portions 31i correspond to an outer surface 31p of peripheral wall portion 31b, and inner surfaces 31u of longitudinal wall portions 31h and inner surfaces 31v of short direction wall portions 31i correspond to an inner surface 31r of peripheral wall portion 31b.

In the exemplary embodiment, socket housing 31 is provided with socket-side signal terminal receiving portions 31f that receive socket-side signal terminals 32. Socket-side signal terminal receiving portions 31f are formed to penetrate through plate-shaped wall portion 31a (see FIG. 14 to FIG. 16). Socket housing 31 is provided with socket-side power source terminal receiving portions 31g that receive socket-side power source terminals 33 in such a way as to penetrate through plate-shaped wall portion 31a.

Socket-side signal terminal receiving portions 31f are formed by forming socket-side signal terminal receiving depressions 31j on longitudinal wall portions 31h in such a way as to communicate with fitting groove portion 31d and forming socket side signal terminal receiving depressions 31m on island portion 31c in such a way as to communicate with fitting groove portion 31d.

Likewise, socket-side power source terminal receiving portions 31g are formed by forming socket-side power source terminal receiving depression 31k in longitudinal wall portions 31h in such a way as to communicate with fitting groove portion 31d and forming socket-side power source terminal receiving depressions 31n in island portion 31c in such a way as to communicate with fitting groove portion 31d.

Socket-side signal terminals 32 and socket-side power source terminals 33 are press-fitted into socket-side signal terminal receiving portions 31f and socket-side power source terminal receiving portions 31g respectively from the back side of socket housing 31.

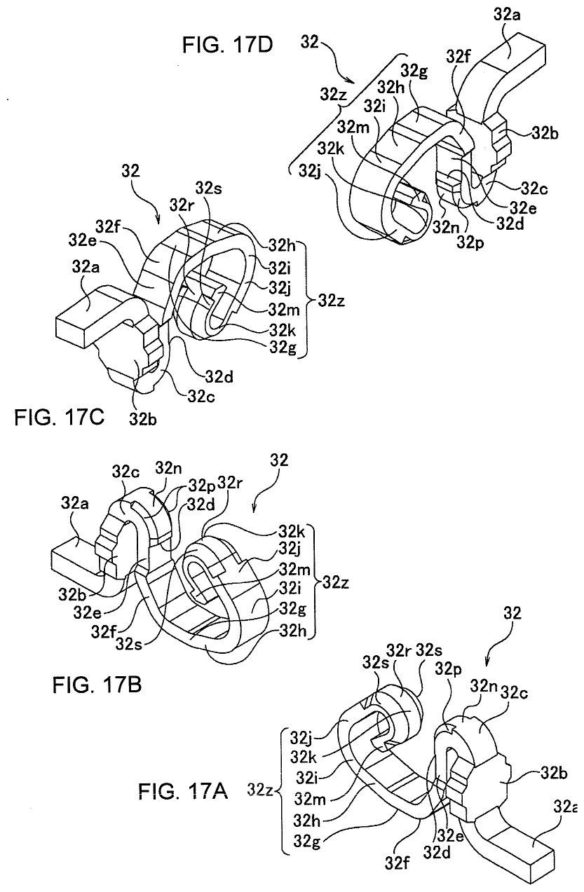

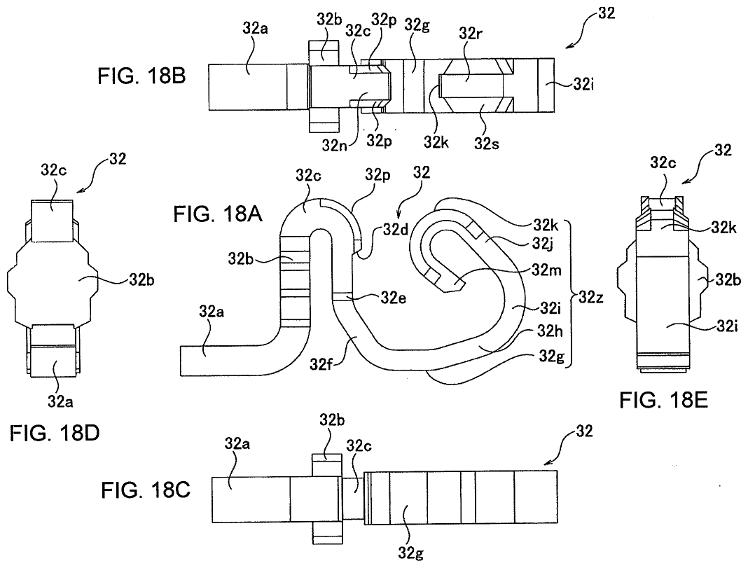

With reference next to FIG. 17 and FIG. 18, a configuration of socket-side signal terminal 32 will be described.

Socket-side signal terminal 32 is manufactured by metal molding and is an electrical conductor. Socket-side signal terminal 32 includes root portion (first socket-terminal-side fixed portion) 32a protruding from a side surface of socket housing 31. Root portion 32a is to be fixed to the circuit pattern of first circuit board 60 by soldering. A lower surface of root portion 32a extends along main surface M of first circuit board 60 and is positioned to be flush with a bottom surface of socket housing 31 (a back surface of plate-shaped wall portion 31a).

Socket-side signal terminal 32 includes rising portion 32b rising from root portion 32a and extends away from first circuit board 60. Rising portion 32b is bent from root portion 32a, enters into the socket-side signal terminal receiving depression 31j, and extends in conformance with inner surface 31u of longitudinal wall portion 31h.

Socket-side signal terminal 32 includes an inverted U-shaped portion 32c continuing at one end to an upper end of rising portion 32b. Inverted U-shaped portion 32c has a shape of a character “U” placed upside down. Inverted U-shaped portion 32c includes a distal end surface 32n and inclined surfaces 32p continuing to distal end surface 32n on both sides in longitudinal direction X, and is formed into a protruding shape protruding in substantially trapezoidal shape in horizontal cross section.

Socket-side signal terminal 32 includes engaging portion 32d continuing to the other end of inverted U-shaped portion 32c. In the exemplary embodiment, engaging portion 32d is formed from one end to the other end of socket housing 31 in longitudinal direction X of socket housing 31 of socket-side signal terminal 32. In other words, engaging portion 32d is formed along the entire width of socket-side signal terminal 32 in a shoulder shape.

As described above, engaging portion 32d functions as a portion to restrict a movement of engaged portion 22e when header-side signal terminal 22 is pulled out from socket-side signal terminal 32. In other words, engaging portion 32d of socket-side signal terminal 32 may abut engaged portion 22e of header-side signal terminal 22 and engage engaged portion 22e. Engaging portion 32d of socket-side signal terminal 32 and engaged portion 22e of header-side signal terminal 22 constitute a lock mechanism configured to allow disengagement by application of an external force larger than the predetermined value.

Engaging portion 32d may be formed by rolling the base material to partly differentiating the thickness of socket-side signal terminal 32 and, alternatively, may be formed by bending the base material of socket-side signal terminal 32 in a thickness direction.

Socket-side signal terminal 32 includes falling portion 32e continuing to engaging portion 32d and extending in substantially parallel to rising portion 32b.

Socket-side signal terminal 32 includes an inclined portion 32f continuing to a lower end of falling portion 32e. Note that socket-side signal terminal 32 may be provided with an arcuate shaped-portion instead of inclined portion 32f.

Socket-side signal terminal 32 includes an opposing portion 32z continuing to the inclined portion 32f as illustrated in FIG. 23 and FIG. 24. Opposing portion 32z includes flat portion 32g, first oblique portion 32h, an arcuate portion 32i, a second oblique portion 32j, an arcuate-shaped projection 32k and distal end portion 32m, as described below. Opposing portion 32z is specifically as follows.

Opposing portion 32z includes flat portion 32g continuing to a lower end of inclined portion 32f. Flat portion 32g extends in conformance with main surface M of first circuit board 60 in a direction away from falling portion 32e as illustrated in FIG. 23. However, flat portion 32g does not have to be parallel to main surface M. Flat portion 32g is provided to increase a spring length of a spring portion described later.

Opposing portion 32z includes first oblique portion 32h continuing to flat portion 32g and extending obliquely with respect to main surface M of first circuit board 60 as illustrated in FIG. 23. First oblique portion 32h extends away from falling portion 32e as it goes away from first circuit board 60. First oblique portion 32h continues to arcuate portion 32i. Arcuate portion 32i is a curved portion protruding away from falling portion 32e. Arcuate portion 32i continues to second oblique portion 32j extending obliquely with respect to main surface M of first circuit board 60. Second oblique portion 32j extends toward falling portion 32e as it goes away from first circuit board 60. Therefore, second oblique portion 32j is positioned above first oblique portion 32h.

As illustrated in FIG. 23, opposing portion 32z is provided with arcuate-shaped projection 32k continuing at one end to an upper end of second oblique portion 32j. Arcuate-shaped projection 32k includes distal end surface 32r and inclined surfaces 32s continuing to distal end surface 32r on both sides in longitudinal direction X, and is formed into a protruding shape protruding in substantially trapezoidal shape in horizontal cross section.

Arcuate-shaped projection 32k fits in depression 22c of header-side signal terminal 22 as illustrated in FIG. 23. The other end of arcuate-shaped projection 32k continues to the distal end portion 32m. The distal end portion 32m extends in substantially parallel to second oblique portion 32j. As is understood from FIG. 23 and FIG. 24, opposing portion 32z (32g, 32h, 32i, 32j, 32k, and 32m) continues to the lower end of the inclined portion 32f, and opposes falling portion 32e as a whole.

In the exemplary embodiment, when header 20 and socket 30 fit each other, header-side signal terminal 22 is inserted between inverted U-shaped portion 32c and arcuate-shaped projection 32k as illustrated in FIG. 24. Falling portion 32e, the inclined portion 32f, flat portion 32g, first oblique portion 32h, arcuate portion 32i, second oblique portion 32j, arcuate-shaped projection 32k, and the distal end portion 32m integrally function as a spring portion. Spring portions (32e, 32f, 32g, 32h, 32i, 32j, 32k, and 32m) resiliently deform when a projection of header-side signal terminal 22 is inserted into the depression of socket-side signal terminal 32. Accordingly, a distance from two portions, that is, falling portion 32e and inverted U-shaped portion 32c to arcuate-shaped projection 32k increases. Engaged portion 22e of header-side signal terminal 22 is then inserted to a position below engaging portion 32d of socket-side signal terminal 32. Accordingly, arcuate-shaped projection 32k of socket-side signal terminal 32 fits depression 22c of header-side signal terminal 22.

With header-side signal terminal 22 fitting socket-side signal terminal 32, the resiliently deformed spring portion generates a restoring force. The restoring force makes arcuate-shaped projection 32k press header-side signal terminal 22 against each of falling portion 32e and inverted U-shaped portion 32c. Accordingly, header-side signal terminal 22 is caught by socket-side signal terminal 32. In this state, header-side signal terminal 22 are in contact with each of inverted U-shaped portion 32c, falling portion 32e, and arcuate-shaped projection 32k of socket-side signal terminal 32.

Specifically, as illustrated in FIG. 23 and FIG. 24, distal end portion 22d of header-side signal terminal 22 comes into contact with falling portion 32e of socket-side signal terminal 32. In other words, contact portion (first socket-terminal-side contact portions) R1 of socket-side signal terminal 32 and contact portion (first header-terminal-side contact portion) R1 of header-side signal terminal 22 come into contact with each other.

Depression 22c of header-side signal terminal 22 comes into contact with arcuate-shaped projection 32k of socket-side signal terminal 32. In other words, contact portion (first socket-terminal-side contact portions) R2 of socket-side signal terminal 32 and contact portion (first header-terminal-side contact portions) R2 of header-side signal terminal 22 come into contact with each other.

In this manner, header-side signal terminal 22 and socket-side signal terminal 32 come into contact with each other at a plurality of contact points (two contact portions; contact portion R1 and contact portion R2) away from each other in width direction Y. Therefore, high reliability of the electric connection between header-side signal terminal 22 and socket-side signal terminal 32 is achieved.

In addition, in the exemplary embodiment, any one of contact portion R2 of socket-side signal terminal 32 and contact portion R2 of header-side signal terminal 22, that is, contact portion R2 of header-side signal terminal 22 is provided with depression 22c. The other contact portion, that is, contact portion R2 of socket-side signal terminal 32 comes into contact with both end portions of depression 22c in longitudinal direction X of socket housing 31.

Specifically, when arcuate-shaped projection 32k of socket-side signal terminal 32 fits depression 22c, boundaries between distal end surface 32r and inclined surfaces 32s of arcuate-shaped projection 32k are in contact respectively with inclined surfaces 22h. In this manner, in the exemplary embodiment, contact portion R2 of socket-side signal terminal 32 comes into contact with contact portion R2 of header-side signal terminal 22 at two points.

Note that a boundary portion between flat portion 32g and first oblique portion 32h may come into contact with first circuit board 60 at contact portion R5 in addition to contact portion R1 and contact portion R2 due to resilient deformation of the spring portion.

In this manner, header-side signal terminal 22 of the exemplary embodiment and socket-side signal terminal 32 are in contact with each other at a plurality of contact points away from each other in width direction Y. However, the header-side signal terminal and the socket-side signal terminal in the present disclosure may include contact only at one point between an inner side surface of the header-side signal terminal and an opposing portion of the socket-side signal terminal.

Spring portion (32e, 32f, 32g, 32h, 32i, 32j, 32k, and 32m) is composed of U-shaped portion (32e, 32f, 32g, 32h, 32i, and 32j) and free ends (32k and 32m) continuing to one end (32j side) of U-shaped portion (32e, 32f, 32g, 32h, 32i, and 32j). Arcuate-shaped projection 32k of free ends (32k and 32m) are provided with contact portion R2 of socket-side signal terminal 32.

In this manner, socket-side signal terminal 32 includes U-shaped portion (32e, 32f, 32g, 32h, 32i, and 32j), and free ends (32k and 32m) provided with contact portion R2 continue to one end (32j side) of U-shaped portion (32e, 32f, 32g, 32h, 32i, and 32j).

Socket-side signal terminal 32 is formed by bending a band-shaped metallic material having a predetermined thickness.

Socket-side signal terminal 32 is attached to socket housing 31 by being inserted (press-fitted) into socket-side signal terminal receiving portions 31f from the back side (the lower side in FIG. 14) of socket housing 31 during assembly of socket 30.

Socket-side signal terminal 32 may be attached to socket housing 31 by insert-molding socket-side signal terminal 32 to socket housing 31, for example.

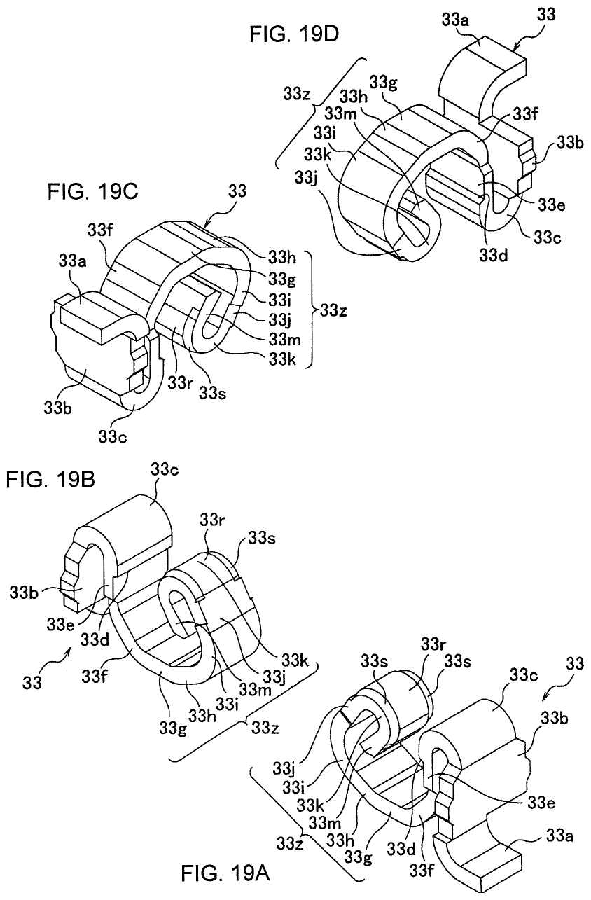

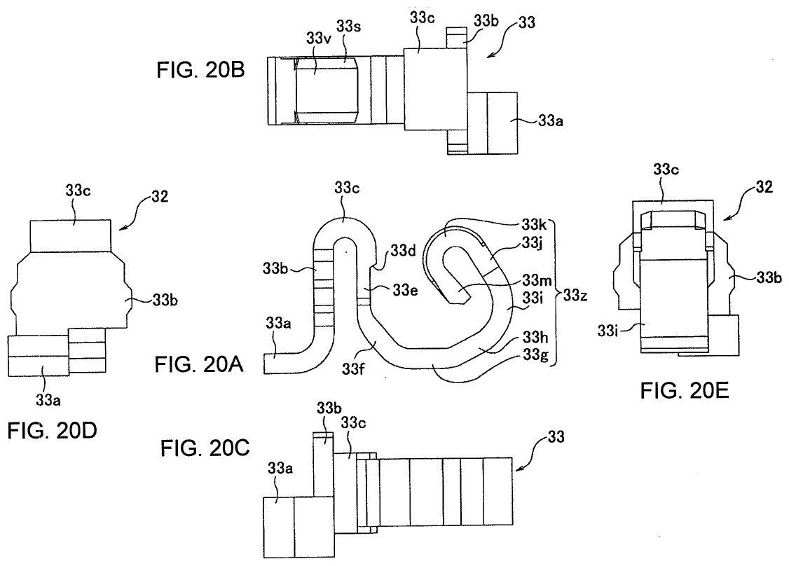

With reference next to FIG. 19 and FIG. 20, a configuration of socket-side power source terminal 33 will be described.

Socket-side power source terminal 33 is manufactured by metal molding and is an electrical conductor. Socket-side power source terminal 33 includes root portion (second socket-terminal-side fixed portion) 33a protruding from side surface of socket housing 31. Root portion 33a is to be fixed to the circuit pattern of first circuit board 60 by soldering. A lower surface of root portion 33a extends along main surface M of first circuit board 60 and is positioned to be flush with a bottom surface of socket housing 31 (a back surface of plate-shaped wall portion 31a).

Socket-side power source terminal 33 includes a rising portion 33b rising from root portion 33a and extends away from first circuit board 60. Rising portion 33b is bent from root portion 33a, enters into the socket-side power source terminal receiving depression 31k, and extends in conformance with inner surface 31u of longitudinal wall portion 31h.

Socket-side power source terminal 33 includes an inverted U-shaped portion 33c continuing at one end to an upper end of rising portion 33b. Inverted U-shaped portion 33c has a shape of a character “U” placed upside down. Inverted U-shaped portion 33c includes distal end surface 33r and inclined surfaces 33s continuing from distal end surface 33r on both sides in longitudinal direction X, and is formed into a protruding shape protruding in substantially trapezoidal shape in horizontal cross section.

Socket-side power source terminal 33 includes engaging portion 33d continuing to the other end of inverted U-shaped portion 33c. As described above, engaging portion 33d functions as a portion to restrict a movement of engaged portion 23d when header-side power source terminal 23 is pulled out from socket-side power source terminal 33. In other words, engaging portion 33d of socket-side power source terminal 33 may abut engaged portion 23d of header-side power source terminal 23 and engage engaged portion 23d. Engaging portion 33d of socket-side power source terminal 33 and engaged portion 23d of header-side power source terminal 23 constitute a lock mechanism configured to allow disengagement by application of an external force larger than the predetermined value.

Engaging portion 33d may be formed by rolling the base material to partly differentiating the thickness of socket-side power source terminal 33 and, alternatively, may be formed by bending the base material of socket-side power source terminal 33 in a thickness direction.

Socket-side power source terminal 33 includes falling portion 33e continuing to engaging portion 33d and extending in substantially parallel to rising portion 33b.

Socket-side power source terminal 33 includes an inclined portion 33f continuing to a lower end of falling portion 33e. Note that socket-side power source terminal 33 may be provided with an arcuate shaped-portion instead of inclined portion 33f.

Socket-side power source terminal 33 includes an opposing portion 33z continuing to inclined portion 33f as illustrated in FIG. 25 and FIG. 26. Opposing portion 33z includes flat portion 33g, first oblique portion 33h, arcuate portion 33i, second oblique portion 33j, arcuate-shaped projection 33k and distal end portion 33m, as described below. Opposing portion 33z is specifically as follows.

Opposing portion 33z includes flat portion 33g continuing to a lower end of inclined portion 33f. Flat portion 33g extends in conformance with main surface M of first circuit board 60 in a direction away from falling portion 33e as illustrated in FIG. 25. However, flat portion 33g does not have to be parallel to main surface M. Flat portion 33g is provided to increase a spring length of a spring portion described later.

Opposing portion 33z includes first oblique portion 33h continuing to flat portion 33g and extending obliquely with respect to main surface M of first circuit board 60 as illustrated in FIG. 25. First oblique portion 33h extends away from falling portion 33e as it goes away from first circuit board 60. First oblique portion 33h continues to arcuate portion 33i. Arcuate portion 33i is a curved portion protruding away from falling portion 33e. Arcuate portion 33i continues to second oblique portion 33j extending obliquely with respect to main surface M of first circuit board 60. Second oblique portion 33j extends toward falling portion 33e as it goes away from first circuit board 60. Therefore, second oblique portion 33j is positioned above first oblique portion 33h.

As illustrated in FIG. 25, opposing portion 33z is provided with arcuate-shaped projection 33k continuing at one end to an upper end of second oblique portion 33j. Arcuate-shaped projection 33k includes distal end surface 33v and inclined surfaces 33w continuing from distal end surface 33v on both sides in longitudinal direction X, and is formed into a protruding shape protruding in substantially trapezoidal shape in horizontal cross section.

Arcuate-shaped projection 33k fits depression 23b of header-side power source terminal 23 as illustrated in FIG. 25. The other end of arcuate-shaped projection 33k continues to distal end portion 33m. Distal end portion 33m extends in substantially parallel to second oblique portion 33j. As is understood from FIG. 25 and FIG. 26, opposing portion 33z (33g, 33h, 33i, 33j, 33k, 33m) continues to the lower end of inclined portion 33f, and opposes falling portion 33e as a whole.

In this manner, in the exemplary embodiment, the shape of a side surface of socket-side signal terminal 32 and the shape of a side surface of socket-side power source terminal 33 are substantially the same (see FIG. 18 (a) and FIG. 20 (a)).

In the exemplary embodiment, when header 20 and socket 30 fit each other, header-side power source terminal 23 is inserted between inverted U-shaped portion 33c and arcuate-shaped projection 33k in the same manner as socket-side signal terminal 32 as illustrated in FIG. 26. Falling portion 33e, inclined portion 33f, flat portion 33g, first oblique portion 33h, arcuate portion 33i, second oblique portion 33j, arcuate-shaped projection 33k, and distal end portion 33m integrally function as a spring portion. Spring portion (33e, 33f, 33g, 33h, 33i, 33j, 33k, and 33m) resiliently deforms when a projection of header-side power source terminal 23 is inserted into the depression of socket-side power source terminal 33.

In the exemplary embodiment, a width (a width along longitudinal direction X) of a portion from inclined portion 33f to distal end portion 33m is smaller than widths of rising portion 33b, inverted U-shaped portion 33c, engaging portion 33d, and falling portion 33e (widths along longitudinal direction X). Therefore, a portion ranged from inclined portion 33f to distal end portion 33m of spring portion (33e, 33f, 33g, 33h, 33i, 33j, 33k, and 33m) is especially susceptible to resilient deformation.

When spring portion (33e, 33f, 33g, 33h, 33i, 33j, 33k, and 33m) resiliently deforms, a distance from two portions, that is, from falling portion 33e and inverted U-shaped portion 33c to arcuate-shaped projection 33k increases. Engaged portion 23d of header-side power source terminal 23 is then inserted to a position below engaging portion 33d of socket-side power source terminal 33. Accordingly, arcuate-shaped projection 33k of socket-side power source terminal 33 fits depression 23b of header-side power source terminal 23.

With header-side power source terminal 23 fitting socket-side power source terminal 33, the resiliently deformed spring portion generates a restoring force. The restoring force makes arcuate-shaped projection 33k press header-side power source terminal 23 against each of falling portion 33e and inverted U-shaped portion 33c. Accordingly, header-side power source terminal 23 is caught by socket-side power source terminal 33. In this state, header-side power source terminal 23 is in contact with each of inverted U-shaped portion 33c, falling portion 33e, and arcuate-shaped projection 33k of socket-side power source terminal 33.

Specifically, as illustrated in FIG. 25 and FIG. 26, distal end portion 23c of header-side power source terminal 23 comes into contact with falling portion 33e of socket-side power source terminal 33. In other words, contact portion (second socket-terminal-side contact portion) R3 of socket-side power source terminal 33 and contact portion (second header-terminal-side contact portion) R3 of header-side power source terminal 23 come into contact with each other.

Depression 23b of header-side power source terminal 23 comes into contact with arcuate-shaped projection 33k of socket-side power source terminal 33. In other words, contact portion (second socket-terminal-side contact portion) R4 of socket-side power source terminal 33 and contact portion (second header-terminal-side contact portion) R4 of header-side power source terminal 23 come into contact with each other.

In this manner, header-side power source terminal 23 and socket-side power source terminal 33 come into contact with each other at a plurality of contact points (two contact portions; contact portion R3 and contact portion R4) away from each other in width direction Y. Therefore, high reliability of the electric connection between header-side power source terminal 23 and socket-side power source terminal 33 is achieved.

Contact portion R3 and contact portion R4 provided at two positions on socket-side power source terminal 33 are located such that contact portion R3 is closer to root portion (second socket-terminal-side fixed portion) 33a than contact portion R4.

In the exemplary embodiment, regarding contact portion R3 and contact portion R4, a cross-sectional area of contact portion R3 located on the closer side to root portion (second socket-terminal-side fixed portion) 33a is larger than a cross-sectional area of contact portion R4 located on the other side. Such a configuration may be obtained by setting the widths (the widths along longitudinal direction X) and the thicknesses (the plate thicknesses) of socket-side power source terminals 33 at contact portion R3 and contact portion R4 adequately.

In the exemplary embodiment, the width (the width along longitudinal direction X) of contact portion R3 of socket-side power source terminal 33 is set to be wider than the width (the width along longitudinal direction X) at contact portion R4.

In the exemplary embodiment, root portion 33a is formed to have a width along longitudinal direction X of socket housing 31 smaller than a width along longitudinal direction X of rising portion 33b. Root portion 33a is continues to an outside portion of rising portion 33b in longitudinal direction X (side farther from socket-side signal terminal 32 adjacent in X direction).

In addition, root portion 33a is offset in a direction away from a root portion (first socket-terminal-side fixed portion) 32a with respect to contact portion R3 and contact portion R4 with socket-side signal terminal 32 and socket-side power source terminal 33 arranged on socket housing 31.

In other words, root portion (second socket-terminal-side fixed portion) 33a continues to rising portion 33b in a state of protruding outward in longitudinal direction X with respect to rising portion 33b.

In this configuration, a distance between root portion (first socket-terminal-side fixed portion) 32a and root portion (second socket-terminal-side fixed portion) 33a is larger than a distance between contact portions (first socket-terminal-side contact portions) R1 and R2 of socket-side signal terminal 32 and contact portions (second socket-terminal-side contact portions) R3 and R4 of socket side power source terminal 33 with the socket-side signal terminal 32 and the socket-side power source terminal 33 disposed on socket housing 31.

Accordingly, the insulation distance between socket-side power source terminal (second socket terminal) 33 and socket-side signal terminal (first socket terminal) 32 (distance between root portion 33a and root portion 32a adjacent to each other in X direction) may be increased.

Note that the insulation distance may be increased by reducing the width of root portion (second socket-terminal-side fixed portion) 33a instead of forming root portion (second socket-terminal-side fixed portion) 33a to protrude outward in longitudinal direction X with respect to rising portion 33b.

As described above, the shape of a side surface of socket-side signal terminal 32 and the shape of a side surface of socket-side power source terminal 33 are substantially the same.

In addition, socket-side signal terminals 32 and socket-side power source terminals 33 are arranged in rows along longitudinal direction X of socket housing 31.

Socket-side power source terminal 33 is formed to have a width along longitudinal direction X of socket housing 31 wider than a width of socket-side signal terminal 32 along longitudinal direction X.

In other words, in the exemplary embodiment, socket-side signal terminal 32 having a smaller width than socket-side power source terminal 33 in longitudinal direction X of socket housing 31 is provided. Note that all socket-side signal terminals 32 have a smaller width than socket-side power source terminals 33 in longitudinal direction X of socket housing 31 in the exemplary embodiment.

In addition, in the exemplary embodiment, the thickness (plate thickness) of socket-side power source terminal 33 is smaller than the thickness (plate thickness) of socket-side signal terminal 32.

Engaging portion 33d is formed from one end to the other end of socket-side power source terminal 33 in longitudinal direction X of socket housing 31. In other words, engaging portion 33d having a shoulder shape is formed along an entire width direction of socket-side power source terminal 33 having a large width. In this configuration, an improved locking force is provided by engaged portion 23d of header-side power source terminal 23 and engaging portion 33d of socket-side power source terminal 33. In addition, abrasion of engaging portion 33d by repeated insertion and withdrawal of header 20 and socket 30 is reduced, and thus longer lifetime of a product is achieved.

In the exemplary embodiment, spring portion (33e, 33f, 33g, 33h, 33i, 33j, 33k, and 33m) is composed of U-shaped portion (33e, 33f, 33g, 33h, 33i, and 33j) and free ends (33k and 33m) continuing to one end (33j side) of U-shaped portion (33e, 33f, 33g, 33h, 33i, and 33j). Arcuate-shaped projection 33k of free ends (33k and 33m) are provided with contact portion R4 of socket-side power source terminal 33.

In this manner, socket-side power source terminal 33 includes U-shaped portion (33e, 33f, 33g, 33h, 33i, and 33j), and free ends (33k and 33m) provided with contact portion R4 continue to one end (33j side) of U-shaped portion (33e, 33f, 33g, 33h, 33i, or 33j).

In addition, in the exemplary embodiment, any one of contact portion R4 of socket-side power source terminal 33 and contact portion R4 of header-side power source terminal 23, that is, contact portion R4 of header-side power source terminal 23 is provided with depression 23b. The other contact portion, that is, contact portion R4 of socket-side power source terminal 33 comes into contact with both end portions of depression 23b in longitudinal direction X of socket housing 31.

Specifically, when arcuate-shaped projection 33k of socket-side power source terminal 33 fits in depression 23b, boundaries between distal end surface 33v and inclined surfaces 33w of arcuate-shaped projection 33k are in contact respectively with inclined surfaces 23h. In this manner, in the exemplary embodiment, contact portion R4 of socket-side power source terminal 33 comes into contact with contact portion R4 of header-side power source terminal 23 at two points.

Note that a boundary portion between flat portion 33g and first oblique portion 33h may come into contact with first circuit board 60 at contact portion R5 in addition to contact portion R3 and contact portion R4 due to resilient deformation of the spring portion.

In this manner, header-side power source terminal 23 and socket-side power source terminal 33 of the exemplary embodiment are in contact with each other at the plurality of contact points away from each other in width direction Y. However, the header-side power source terminal and the socket-side power source terminal in the present disclosure may include contact only one contact point between an inner side surface of the header-side power source terminal and an opposing portion of the socket-side power source terminal.

Socket-side power source terminal 33 is formed by bending a band-shaped metallic material having a predetermined thickness.

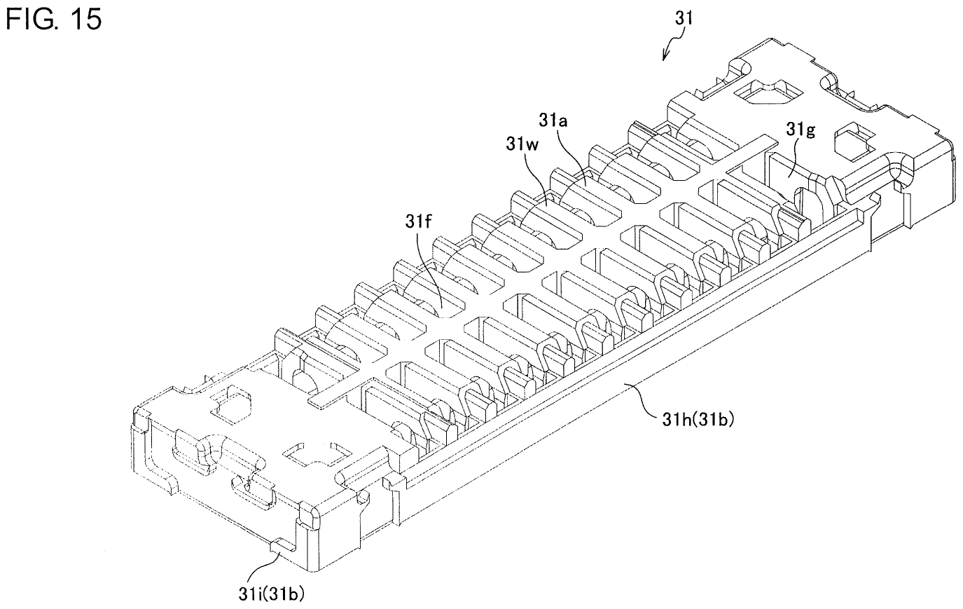

Socket-side power source terminal 33 is attached to socket housing 31 by being inserted (press-fitted) into socket-side power source terminal receiving portions 31g from the back side (the lower side in FIG. 15) of socket housing 31 during assembly of socket 30.

Socket-side power source terminal 33 may be attached to socket housing 31 by, for example, insert-molding socket-side power source terminal 33 to socket housing 31, for example.

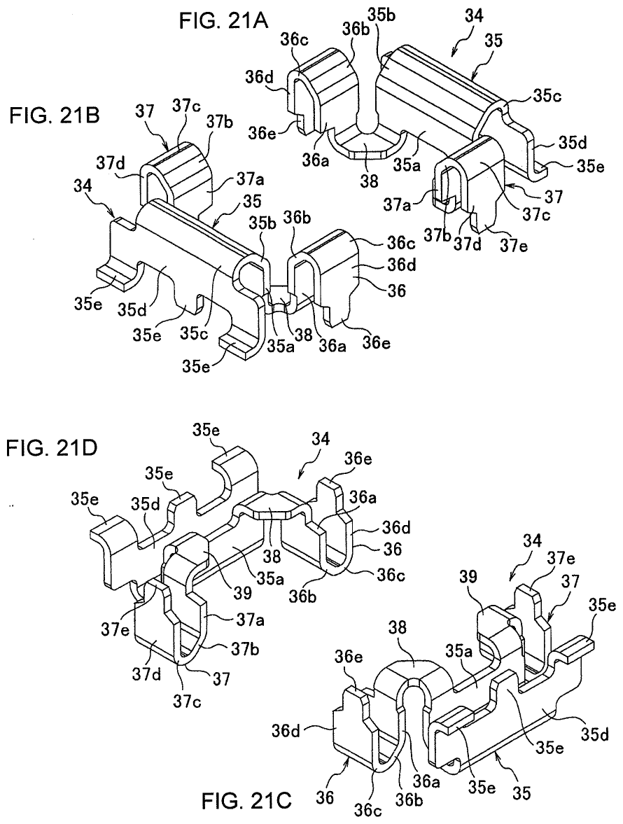

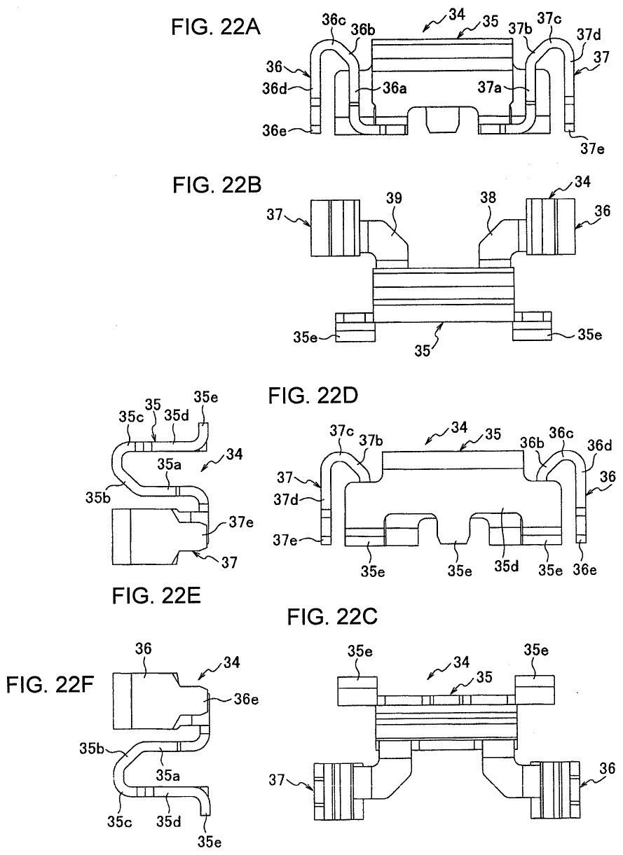

With reference next to FIG. 21 and FIG. 22, a configuration of socket-side retaining fixture 34 will be described.

Socket-side retaining fixture 34 is manufactured by metal molding and is an electrical conductor. Socket-side retaining fixture 34 may be formed by bending a retaining fixture plate formed by press-molding a metal plate having a predetermined thickness.

In the exemplary embodiment, socket-side retaining fixture 34 includes first inverted U-shaped portion (first U-shaped portion) 35 extending in a width direction (short direction: one direction) Y.

Socket-side retaining fixture 34 includes second inverted U-shaped portion (second U-shaped portion) 36 extending in longitudinal direction (the direction intersecting the one direction) X and located on one side in width direction Y of first inverted U-shaped portion 35.

In addition, socket-side retaining fixture 34 includes third inverted U-shaped portion (third U-shaped portion) 37 extending in longitudinal direction (the direction intersecting the one direction) X and disposed on other side in width direction Y of first inverted U-shaped portion 35.

In the exemplary embodiment, second inverted U-shaped portion 36 is disposed adjacent to socket-side power source terminal 33 in longitudinal direction X, and third inverted U-shaped portion 37 is disposed adjacent to socket-side signal terminal 32 in longitudinal direction X.

First inverted U-shaped portion 35, second inverted U-shaped portion 36, and third inverted U-shaped portion 37 are disposed at a distance from each other.

First inverted U-shaped portion 35 includes rising portion 35a disposed in conformance with the inner surface of socket housing 31 (inner surfaces 31v of short direction wall portions 31i). Rising portion 35a rises from a joint portion between plate-shaped wall portion 31a and short direction wall portions 31i of socket housing 31 and extends away from first circuit board 60.

First inverted U-shaped portion 35 includes an inclined portion 35b continuing to an upper end of rising portion 35a. Inclined portion 35b inclines downward (toward plate-shaped wall portion 31a) as it goes inward in the similar manner to tapered portion 31e of socket housing 31.

First inverted U-shaped portion 35 includes arcuate shaped portion 35c continuing to an upper end of inclined portion 35b. Arcuate shaped portion 35c is a curved portion protruding away from inclined portion 35b.

First inverted U-shaped portion 35 includes falling portion 35d continuing to arcuate shaped portion 35c and extending substantially parallel to rising portion 35a. Falling portion 35d extends along outer surface 31t of short direction wall portions 31i.

In addition, first inverted U-shaped portion 35 is provided with first fixed portions 35e to be fixed to the circuit pattern of first circuit board 60 by soldering.

In this exemplary embodiment, part of a distal end (lower end) of falling portion 35d is protruded slightly with respect to an outer surface 31w of plate-shaped wall portion 31a. The distal end (lower end) of falling portion 35d protruding slightly from outer surface 31W is fixed to the circuit pattern of first circuit board 60 by soldering.

In the exemplary embodiment, falling portion 35d is formed to have a width (the length in width direction Y) wider (larger) than a width (the length in width direction Y) of arcuate shaped portion 35c. First fixed portions 35e are formed at both ends and center of falling portion 35d in width direction Y.

The distal ends of falling portion 35d on the both end sides in width direction Y have a shape bent to extend along XY plane (main surface M of first circuit board 60). In other words, the distal ends of falling portion 35d on the both end sides in width direction Y are formed to protrude outward in X direction and thus first fixed portions 35e are formed on the both end sides of falling portion 35d in width direction Y. In contrast, the distal end of falling portion 35d on the both end sides in width direction Y does not have a bent shape, and thus first fixed portion 35e formed at this position is fixed to the circuit pattern of first circuit board 60 with the distal end abutting main surface M of first circuit board 60.

In this manner, first fixed portions 35e provided at the both ends and the center of falling portion 35d having a wide width achieve stronger fixation of socket-side retaining fixture 34 to first circuit board 60.

Second inverted U-shaped portion 36 includes rising portion 36a disposed in conformance with the inner surface of socket housing 31 (inner surfaces 31u of longitudinal direction wall portion 31h). Rising portion 36a rises from a joint portion between plate-shaped wall portion 31a and longitudinal wall portions 31h of socket housing 31 and extends away from first circuit board 60.

Second inverted U-shaped portion 36 includes an inclined portion 36b continuing to an upper end of rising portion 36a. Inclined portion 36b inclines in the similar manner to tapered portion 31e of socket housing 31 and extends downward (toward plate-shaped wall portion 31a) as it goes inward.

Second inverted U-shaped portion 36 includes arcuate shaped portion 36c continuing to an upper end of inclined portion 36b. Arcuate shaped portion 36c is a curved portion protruding away from inclined portion 36b.

Second inverted U-shaped portion 36 includes falling portion 36d continuing to arcuate shaped portion 36c and extending substantially parallel to rising portion 36a. Falling portion 36d extends along outer surface 31s of longitudinal wall portions 31h.

In addition, second inverted U-shaped portion 36 is provided with second fixed portion 36e to be fixed to the circuit pattern of first circuit board 60 by soldering.

In this exemplary embodiment, part (the center in X direction) of a distal end (lower end) of falling portion 36d is protruded slightly with respect to an outer surface 31w of plate-shaped wall portion 31a. The distal end (lower end) of falling portion 36d protruding slightly from outer surface 31W is fixed to the circuit pattern of first circuit board 60 by soldering.

In the exemplary embodiment, second fixed portion 36e is fixed to the circuit pattern of first circuit board 60 with the distal end abutting main surface M of first circuit board 60.

Third inverted U-shaped portion 37 includes rising portion 37a disposed in conformance with the inner surface of socket housing 31 (inner surfaces 31u of longitudinal wall portions 31h). Rising portion 37a rises from a joint portion between plate-shaped wall portion 31a and longitudinal wall portions 31h of socket housing 31 and extends away from first circuit board 60.

Third inverted U-shaped portion 37 includes inclined portion 37b continuing to an upper end of rising portion 37a. Inclined portion 37b inclines in the similar manner to tapered portion 31e of socket housing 31 and extends downward (toward plate-shaped wall portion 31a) as it goes inward.

Third inverted U-shaped portion 37 includes arcuate shaped portion 37c continuing to an upper end of inclined portion 37b. Arcuate shaped portion 37c is a curved portion protruding away from inclined portion 37b.

Third inverted U-shaped portion 37 includes falling portion 37d continuing to arcuate shaped portion 37c and extending substantially parallel to rising portion 37a. Falling portion 37d extends along outer surface 31s of longitudinal wall portions 31h.

In addition, third inverted U-shaped portion 37 is provided with third fixed portion 37e to be fixed to the circuit pattern of first circuit board 60 by soldering.

In the exemplary embodiment, part (the center in X direction) of a distal end (lower end) of falling portion 37d is protruded slightly with respect to outer surface 31w of plate-shaped wall portion 31a. The distal end (lower end) of falling portion 37d protruding slightly from outer surface 31W is fixed to the circuit pattern of first circuit board 60 by soldering.

In the exemplary embodiment, third fixed portion 37e is fixed to the circuit pattern of first circuit board 60 with the distal end abutting main surface M of first circuit board 60.

In this manner, in the exemplary embodiment, socket-side retaining fixture 34 includes first fixed portions 35e formed in the vicinity of first inverted U-shaped portion 35, second fixed portion 36e formed in the vicinity of second inverted U-shaped portion 36, and third fixed portion 37e formed in the vicinity of third inverted U-shaped portion 37.

First fixed portions 35e continue to first inverted U-shaped portion 35, second fixed portion 36e continues to second inverted U-shaped portion 36, and third fixed portion 37e continues to third inverted U-shaped portion 37.

In addition, in the exemplary embodiment, a side of second inverted U-shaped portion 36 having no second fixed portion 36e continues to a side of first inverted U-shaped portion 35 not continuing to first fixed portions 35e.

Specifically, rising portion 36a of second inverted U-shaped portion 36 and rising portion 35a of first inverted U-shaped portion 35 continue to each other via joint portion 38.

Joint portion 38 joins an outer side in longitudinal direction X of a lower end of rising portion 36a and an outer side in width direction Y of a lower end of rising portion 35a.

In contrast, a side of third inverted U-shaped portion 37 having no third fixed portion 37e continues to a side of first inverted U-shaped portion 35 not continuing to first fixed portions 35e.

Specifically, rising portion 37a of third inverted U-shaped portion 37 and rising portion 35a of first inverted U-shaped portion 35 continue to each other via joint portion 39.

Joint portion 39 joins an outer side in longitudinal direction X of a lower end of rising portion 37a and an outer side in width direction Y of a lower end of rising portion 35a.

In this manner, in the exemplary embodiment, first fixed portions 35e, second fixed portion 36e, and third fixed portion 37e are provided at free ends not continuing to first inverted U-shaped portion 35, second inverted U-shaped portion 36, and third inverted U-shaped portion 37.

Accordingly, fixing points are formed at three directions (one end in longitudinal direction X and both ends in width direction Y), and thus strong fixation of socket-side retaining fixture 34 to first circuit board 60 is achieved.

In particular, free end of socket-side retaining fixture 34 is provided with a fixed portion, socket-side retaining fixture 34 resists deformation, and stronger fixation of socket-side retaining fixture 34 to first circuit board 60 is achieved.

In the exemplary embodiment, socket-side retaining fixture 34 is mounted (disposed) on socket housing 31 by insert molding. At the time of molding, at least part of socket-side retaining fixture 34 is exposed along socket housing 31.

In other words, at least part of socket-side retaining fixture 34 is exposed along an outer surface of socket housing 31.

Specifically, first inverted U-shaped portion 35 is exposed from inner surface (inner surface 31r of peripheral wall portion 31b) 31v side of short direction wall portions 31i toward outer surface (outer surface 31p of peripheral wall portion 31b) 31t side of short direction wall portions 31i.

In the exemplary embodiment, substantially entire part of first inverted U-shaped portion 35 (rising portion 35a, inclined portion 35b, arcuate shaped portion 35c, falling portion 35d, and first fixed portions 35e) is exposed along an outer surface of socket housing 31.

Parts of peripheral wall portion 31b and plate-shaped wall portion 31a are substantially flush with falling portion 35d of socket-side retaining fixture 34. In other words, socket-side retaining fixture 34 is integrally molded with socket housing 31, and falling portion 35d of socket-side retaining fixture 34 is exposed in substantially flush with the outer surface of the peripheral wall portion 31b.

In addition, second inverted U-shaped portion 36 is exposed from inner surface (inner surface 31r of peripheral wall portion 31b) 31u side of longitudinal wall portions 31h toward outer surface (outer surface 31p of peripheral wall portion 31b) 31s side of longitudinal wall portions 31hi.

In the exemplary embodiment, substantially entire part of second inverted U-shaped portion 36 (rising portion 36a, inclined portion 36b, arcuate shaped portion 36c, falling portion 36d, and second fixed portions 36e) is exposed along an outer surface of socket housing 31.

Parts of peripheral wall portion 31b and plate-shaped wall portion 31a are substantially flush with falling portion 36d of socket-side retaining fixture 34. In other words, socket-side retaining fixture 34 is integrally formed with socket housing 31 and falling portion 36d of socket-side retaining fixture 34 is exposed in flush with the outer surface of peripheral wall portion 31b.

In addition, third inverted U-shaped portion 37 is exposed from inner surface (inner surface 31r of peripheral wall portion 31b) 31u side of longitudinal wall portions 31h toward outer surface (outer surface 31p of peripheral wall portion 31b) 31s side of longitudinal wall portions 31h.

In the exemplary embodiment, substantially entire part of third inverted U-shaped portion 37 (rising portion 37a, inclined portion 37b, arcuate shaped portion 37c, falling portion 37d, and third fixed portion 37e) is exposed along an outer surface of socket housing 31.

Parts of peripheral wall portion 31b and plate-shaped wall portion 31a are substantially flush with falling portion 37d of socket-side retaining fixture 34. In other words, socket-side retaining fixture 34 is integrally molded with socket housing 31, and falling portion 37d of socket-side retaining fixture 34 is exposed in substantially flush with the outer surface of the peripheral wall portion 31b.

In the exemplary embodiment, joint portion 38 and joint portion 39 are exposed in flush with the bottom surface (outer surface 31w of plate-shaped wall portion 31a) of socket housing 31. However, joint portion 38 and joint portion 39 may be exposed in flush with the bottom surface (outer surface 31w of plate-shaped wall portion 31a) of socket housing 31. Socket-side retaining fixture 34 does not have to be exposed from outer surface 31p of peripheral wall portion 31b, and socket-side retaining fixture 34 does not have to be flush with outer surface 31p of peripheral wall portion 31b when exposed.

As illustrated in FIG. 25 and FIG. 26, header 20 fits socket 30 by inserting and fitting peripheral wall portion 21b of header housing 21 in fitting groove portion 31d of socket housing 31.

For fitting header 20 in socket 30, for example, tapered portions 31e and tapered portion 21d formed on a longitudinal side portion on one end side in Y direction (width direction: short direction) are overlapped each other and then header 20 is shifted in Y direction (width direction: short direction) to be fitted in socket 30. In this configuration, tapered portions 31e and tapered portion 21d may be functioned as guiding portions to achieve easier fitting of header 20 into socket 30.

During this operation, a joint part (curved portion) between lower wall portion 24a and side wall portions of the header-side retaining fixture 24 is in contact with at least one of inclined portions 35b, 36b, and 37b during introduction into fitting groove portion 31d.

Contact portion R1 of socket-side signal terminal 32 and contact portion R1 of header-side signal terminal 22 are in contact with each other when header 20 fits socket 30.

Likewise, contact portion R2 of socket-side signal terminal 32 and contact portion R2 of header-side signal terminal 22 are in contact with each other.

Contact portion R3 of socket-side power source terminal 33 and contact portion R3 of header-side power source terminal 23 are also in contact with each other.

Likewise, contact portion R4 of socket-side power source terminal 33 and contact portion R4 of header-side power source terminal 23 are also in contact with each other.

Consequently, socket-side signal terminal 32 and header-side signal terminal 22 are electrically connected and socket-side power source terminal 33 and header-side power source terminal 23 are electrically connected.

Likewise, header-side retaining fixture 24 and socket-side retaining fixture 34 are electrically connected via socket-side power source terminal 33 and header-side power source terminal 23.

In this manner, the circuit pattern of first circuit board 60 and the circuit pattern of second circuit board 40 are electrically connected to each other.

In this state, first side wall portions 24b and side strips 24c of header-side retaining fixture 24 may be in contact with any one of falling portions 35d, 36d, or 37d of socket-side retaining fixture 34. Header-side retaining fixture 24 and socket-side retaining fixture 34 may not come into contact with each other when header 20 fits socket 30.

In contrast, when disconnecting header 20 and socket 30, header 20 and socket 30 are pulled away from each other. Consequently, while engaging portion 32d having a shoulder shape and engaged portion 22e having a shoulder shape slide with respect to each other, spring portion (32e, 32f, 32g, 32h, 32i, 32j, 32k, and 32m) of socket-side signal terminal 32 resiliently deforms and engagement between engaging portion 33d and engaged portion 32e is released. Simultaneously, fitting of arcuate-shaped projection 32k in depression 22c is also released.

Likewise, while engaging portion 33d having a shoulder shape and engaged portion 23d having a shoulder shape slide with respect to each other, spring portion (33e, 33f, 33g, 33h, 33i, 33j, 33k, and 33m) of socket-side power source terminal 33 resiliently deforms and engagement between engaging portion 33d and engaged portion 23d is released. Simultaneously, fitting of arcuate-shaped projection 33k in depression 23b is also released.

In this manner, separation of header 20 and socket 30 is enabled.

Alternatively, header-side retaining fixture 24 and socket-side retaining fixture 34 may be provided with a locking mechanism to cause header-side retaining fixture 24 and socket-side retaining fixture 34 to engage each other when header 20 fits socket 30.

Note that in the exemplary embodiment, header-side signal terminals 22 and header-side power source terminals 23 are attached to header housing 21 so that distal end portions located on the socket 30 side when header 20 fits socket 30 are substantially aligned in height.

Note that, socket-side signal terminals 32 and socket-side power source terminals 33 are attached to socket housing 31 so that distal end portions located on header 20 side when header 20 fits socket 30 are substantially aligned in height.

Therefore, when header 20 fits socket 30, contact between header-side power source terminals 23 and socket-side power source terminals 33 and contact between header-side signal terminals 22 and socket-side signal terminals 32 are substantially simultaneously achieved.

In contrast, for separating header 20 and socket 30, contact between header-side power source terminals 23 and socket-side power source terminals 33 and contact between header-side signal terminals 22 and socket-side signal terminal 32 are substantially simultaneously broken.

In the exemplary embodiment, as described above, header-side retaining fixtures 24 are disposed at both ends in longitudinal direction X of header housing 21 and socket-side retaining fixtures 34 are disposed at both ends in the longitudinal direction X of socket housing 31. Header-side retaining fixtures 24 and socket-side retaining fixtures 34 are used for enhancing strength of header housing 21 and socket housing 31 and fixedly attaching to the above-described circuit board.

In the configuration of the exemplary embodiment, strong connection of header 20 to second circuit board 40 is achieved by soldering the fixed portions of header-side retaining fixtures 24 to second circuit board 40.

Likewise, strong connection of socket 30 to first circuit board 60 is achieved by soldering fixed portions of socket-side retaining fixtures 34 to first circuit board 60.

In this configuration, header 20 and socket 30 strongly coupled to the respective circuit boards may be fitted to each other.

As described thus far, connector 10 of the exemplary embodiment includes socket 30 including substantially rectangular socket housing 31 and socket-side signal terminals (first socket terminals) 32 and socket-side power source terminals (second socket terminals) 33 having a larger width than socket-side signal terminals (first socket terminals) 32 are disposed in substantially rectangular socket housing 31.

Likewise, connector 10 includes header 20 including substantially rectangular header housing 21. On the substantially rectangular header housing, header-side signal terminals (first header terminals) 22 and header-side power source terminals (second header terminal) 23 having a larger width than header-side signal terminals (first header terminal) 22.

In addition, socket-side power source terminals (second header terminals) 33 are disposed at two positions, that is, at a position on one side in longitudinal direction X and one side in short direction Y of socket housing 31 and at a position on the other side in longitudinal direction X and on other side in short direction Y of socket housing 31.

In other words, socket housing 31 includes only two pieces of socket-side power source terminals (second socket terminals) 33, and the two pieces of socket-side power source terminals (second socket terminals) 33 are arranged at opposing corners of socket housing 31 having a rectangular (oblong) shape.

In this configuration, socket-side signal terminals (first socket terminals) 32 may be arranged at diagonal portions having no socket-side power source terminals (second socket terminals) 33 of rectangular (oblong) shaped socket housing 31.

Consequently, socket housing 31 compact in longitudinal direction X is achieved.

Likewise, socket 30 of the exemplary embodiment includes substantially rectangular socket housing 31. Socket-side signal terminals (first socket terminals) 32 and socket-side power source terminal (second socket terminal) 33 having a larger width than socket-side signal terminals (first socket terminals) 32 are disposed in socket 30.

In addition, socket-side power source terminals (second socket terminals) 33 are disposed at two positions, that is, at a position on one side in longitudinal direction X and one side in short direction Y of socket housing 31 and at a position on the other side in longitudinal direction X and on other side in short direction Y of socket housing 31.

In this configuration, socket housing 31 compact in longitudinal direction X is achieved.

Likewise, header 20 of the exemplary embodiment includes substantially rectangular header housing 21. Header-side signal terminals (first header terminals) 22 and header-side power source terminals (second header terminal) 23 having a larger width than header-side signal terminals (first header terminal) 22 are disposed in header housing 21.

In addition, header-side power source terminals (second header terminals) 23 are disposed at two positions, that is, at a position on one side in longitudinal direction X and one side in short direction Y of header housing 21 and at a position on the other side in longitudinal direction X and on other side in short direction Y of header housing 21.

In this configuration, header housing 21 compact in longitudinal direction X is achieved.

In this manner, according to the exemplary embodiment, further compact connector 10, header 20, and socket 30 are achieved.

In the exemplary embodiment, header 20 is point symmetry with respect to a center of the header 20 in plan view and socket 30 is point symmetry with respect to a center of the socket 30 in plan view. Therefore, breakage of header 20 and socket 30 by inverted fitting may be prevented or reduced.

In addition, in the exemplary embodiment, the shape of the side surface of socket-side signal terminal (first socket terminal) 32 and the shape of the side surface of socket-side power source terminal (second socket terminal) 33 are substantially the same.

In addition, socket-side signal terminals (first socket terminals) 32 and socket-side power source terminals (second socket terminals) 33 are arranged in rows along longitudinal direction X of socket housing 31.

In this configuration, good fitting balance is achieved between socket-side signal terminals (first socket terminals) 32 and socket-side power source terminals (second socket terminals) 33 and thus easy fitting of header 20 into socket 30 is achieved.

In addition to capability of easily designing terminals having improved contact reliability, improved fitting-retention force between header 20 and socket 30 is also achieved.

In the exemplary embodiment, socket-side signal terminal group (first socket terminal group) G4 including a plurality of socket-side signal terminals 32 arranged along longitudinal direction X of socket housing 31 is provided.

In contrast, socket-side power source terminals 33 are arranged outer side longitudinal direction X of socket housing 31 with respect to the socket-side signal terminal group G4.

By disposing the socket-side power source terminals 33 having a larger calorific power on the outer side in the longitudinal direction X of the socket housing 31 with respect to socket-side signal terminal group G4 as described above, higher heat dissipation properties are achieved.

In addition, by arranging the plurality of socket-side signal terminals 32 only on one side in the longitudinal direction X of the socket-side power source terminals 33, noise that may generate in the socket-side signal terminals 32 may be reduced.

In the exemplary embodiment, socket-side signal terminal (first socket terminal) 32 includes first socket-terminal-side contact portions R1 and R2 that header-side signal terminal (first header terminal) 22 comes into contact with and root portion (first socket-terminal-side fixed portion) 32a configured to be fixed to first circuit board (circuit board) 60.

In contrast, socket-side power source terminal (second socket terminal) 33 includes second socket-terminal-side contact portions R3 and R4 that header-side power source terminal (second header terminal) 23 comes into contact with and root portion (second socket-terminal-side fixed portion) 33a configured to be fixed to first circuit board (circuit board) 60.

Furthermore, a distance between root portion (first socket-terminal-side fixed portion) 32a and root portion (second socket-terminal-side fixed portion) 33a is larger than a distance between contact portions (first socket-terminal-side contact portions) R1 and R2 of socket-side signal terminal 32 and contact portions (second socket-terminal-side contact portions) R3 and R4 of socket side power source terminal 33 with socket-side signal terminals 32 and socket-side power source terminals 33 disposed in the socket housing 31.

Accordingly, the insulation distance between socket-side power source terminal (second socket terminal) 33 and socket-side signal terminal (first socket terminal) 32 (distance between root portion 33a and root portion 32a adjacent to each other in X direction) may be increased.

In the exemplary embodiment, socket-side power source terminal (second socket terminal) 33 includes second socket-terminal-side contact portions at two points, R3 and R4.

Regarding contact portion R3 and contact portion R4, a cross-sectional area of contact portion R3 located on the closer side to root portion (second socket-terminal-side fixed portion) 33a is larger than a cross-sectional area of contact portion R4 located on the other side. The cross-sectional area of one R3 of second socket-terminal-side contact portions R3 and R4 located on the closer side to root portion (second socket-terminal-side fixed portion) 33a is larger than the cross-sectional area of second socket-terminal-side contact portion R4 located on the other side.

In this configuration, conductor resistance of socket-side power source terminals (second socket terminals) 33 may be efficiently reduced.

In the exemplary embodiment, the thickness of socket-side power source terminal (second socket terminal) 33 is thinner than the thickness of socket-side signal terminal (first socket terminal) 32.

In this configuration, a contact force of wide socket-side power source terminal (second socket terminal) 33 with respect to header-side power source terminal (second header terminal) 23 may be brought closer to a contact force between narrow socket-side signal terminal (first socket terminal) 32 with respect to header-side signal terminal (first header terminal) 22.

Consequently, good fitting balance is achieved between socket-side signal terminals (first socket terminals) 32 and socket-side power source terminals (second socket terminals) 33 and thus easy fitting of header 20 into socket 30 is achieved.

In addition, as improved bending workability is achieved during formation of socket-side power source terminal (second socket terminal) 33, and thus generation of cracks, for example, may be prevented or reduced. Consequently, socket-side power source terminal (second socket terminal) 33 may be stabilized in the conductor resistance and the contact force with respect to header-side power source terminal (second header terminal) 23.

In addition, in the exemplary embodiment, socket-side power source terminal (second socket terminal) 33 includes engaging portion 33d to be engaged with header-side power source terminal (second header terminal) 23.

In this configuration, fitting retention force between header 20 and socket 30 may be improved.

In addition, in the exemplary embodiment, header-side power source terminal (second header terminal) 23 includes engaged portion 23d configured to engage engaging portion 33d of socket-side power source terminal (second socket terminal) 33.

In this configuration, fitting retention force between header 20 and socket 30 may further be improved.

In the exemplary embodiment, socket-side retaining fixtures 34 are disposed in socket housing 31, and socket-side power source terminals (second socket terminals) 33 are also disposed separately from socket-side retaining fixtures 34.

This simplifies configurations of socket-side power source terminals (second socket terminals) 33 and configuration of socket-side retaining fixtures 34.

Compared with socket-side power source terminal (second socket terminal) 33 integrated with socket-side retaining fixture 34, further accurate socket-side power source terminal (second socket terminal) 33 and socket-side retaining fixture 34 are achieved.

In the exemplary embodiment, header-side retaining fixtures 24 are disposed in header housing 21, and header-side retaining fixtures 24 are each formed integrally with header-side power source terminal (second header terminal) 23.

In this configuration, heat generating in header-side power source terminal (second header terminal) 23 may be dissipated further efficiently.

In the exemplary embodiment, socket-side retaining fixture 34 and header-side retaining fixture 24 are electrically connected.

In this configuration, heat generating in socket-side power source terminal (second socket terminal) 33 and header-side power source terminal (second header terminal) 23 may be dissipated further efficiently. Consequently, rated current may be improved.

Socket-side retaining fixture (retaining fixture used in one of connector coupling bodies) 34 is insert-molded into socket housing (housing of connector coupling body) 31 of socket 30.

Socket-side retaining fixture 34 includes first inverted U-shaped portion (first U-shaped portion) 35 extending in the width direction (one direction) Y, second inverted U-shaped portion (second U-shaped portion) 36 extending in the longitudinal direction (the direction intersecting the one direction) X and disposed on one side in the width direction (one direction) Y of first inverted U-shaped portion 35, and third inverted U-shaped portion (third U-shaped portion) 37 extending in the longitudinal direction (the direction intersecting the one direction) X and disposed on the other side in the width direction (one direction) Y of the first inverted U-shaped portion 35.

First inverted U-shaped portion 35, second inverted U-shaped portion 36, and third inverted U-shaped portion 37 are molded in peripheral wall portion 31b formed in socket housing (housing of connector coupling body) 31 by insert molding.

In this configuration, further improved strength of socket housing (housing of connector coupling body) 31 is achieved.

In this manner, according to the exemplary embodiment, socket-side retaining fixture (retaining fixture) 34 capable of improving the strength of socket housing (housing) 31 of socket (connector coupling body) 30 is provided. In addition, socket (connector coupling body) 30 provided with socket-side retaining fixture (retaining fixture) 34 and connector 10 may be provided.

In the exemplary embodiment, first inverted U-shaped portion 35, second inverted U-shaped portion 36, and third inverted U-shaped portion 37 are exposed on inner surface 31r side of peripheral wall portion 31b.

For example, when each inverted U-shaped portion is embedded in socket housing (housing of connector coupling body) 31, socket housing (housing of connector coupling body) 31 is divided. In contrast, as in the exemplary embodiment, exposing each inverted U-shaped portion from inner surface 31r side of peripheral wall portion 31b may prevent socket housing (housing of connector coupling body) 31 from being decoupled. Consequently, further improvement of strength of socket housing (housing of connector coupling body) 31 is achieved.

Furthermore, in the exemplary embodiment, first inverted U-shaped portion 35, second inverted U-shaped portion 36, and third inverted U-shaped portion 37 are exposed from inner surface 31r side to outer surface 31p side of peripheral wall portion 31b.

In this configuration, deformation of peripheral wall portion 31b when header 20 and socket 30 fit, for example, may be prevented or reduced.

In the exemplary embodiment, a fixed portion to be fixed to first circuit board (circuit board) 60 is further provided.

The fixed portion includes first fixed portions 35e formed in the vicinity of first inverted U-shaped portion 35, second fixed portion 36e formed in the vicinity of second inverted U-shaped portion 36, and third fixed portion 37e formed in the vicinity of third inverted U-shaped portion 37.

In this configuration, stronger fixation of socket 30 to first circuit board (circuit board) 60 is achieved.

In the exemplary embodiment, first fixed portions 35e continue to first inverted U-shaped portion 35, second fixed portion 36e continues to second inverted U-shaped portion 36, and third fixed portion 37e continues to third inverted U-shaped portion 37.

In the exemplary embodiment, second inverted U-shaped portion 36 continues to first inverted U-shaped portion 35. The side of second inverted U-shaped portion 36 not coupled to second fixed portion 36e continues to the side of first inverted U-shaped portion 35 not continuing to first fixed portions 35e.

In this configuration, stronger fixation of socket 30 to first circuit board (circuit board) 60 is achieved.

Gap d2 is formed between fixed portions (first fixed portions 35e, second fixed portion 36e, and third fixed portion 37e) and socket housing 31. Gap d2 functions as a run-out for solder when the fixed portions are soldered, or functions as a heat-releasing portion to avoid an excessive temperature increase of socket housing 31.

In the exemplary embodiment, first inverted U-shaped portion 35, second inverted U-shaped portion 36, and third inverted U-shaped portion 37 are electrically connected to header-side retaining fixture (fixture) 24 provided on header (counterpart member of connector coupling body) 20.

In this configuration, further efficient dissipation of heat generating in socket-side retaining fixture 34 and header-side retaining fixture (fixture) 24 is achieved. Consequently, rated current may be improved.

The scope of the present disclosure should not be limited to the exemplary embodiment described above, and should include various modifications and alterations.

For example, exemplified in the exemplary embodiment described above is a configuration (connector without any polarity) including header 20 being point symmetry with respect to a center of the header 20 in plan view and socket 30 being point symmetry with respect to a center of the socket 30 in plan view.

However, a connector having a polarity (a connector providing a different shape when rotated by 180 degrees) may be applied to the present disclosure.

The header-side retaining fixture and the socket-side retaining fixture may engage each other when header 20 fits socket 30.

The second socket terminal and the second header terminal may be used as terminals for ground connection. In this configuration, further improvement of reliability of the ground connection is achieved.

Alternatively the following configuration is also applicable. The second socket terminal is provided separately from the socket-side retaining fixture, the second header terminal and the second socket terminal are used as power supply terminals, and the socket-side retaining fixture and the header-side retaining fixture are used as ground connection terminals.

The present disclosure may be applied to the header used as the connector coupling body.

The socket side housing, the header-side housing, and other detailed specifications (shape, size, layout, etc.,) may be modified as appropriate.

### REFERENCE MARKS IN THE DRAWINGS

10: connector
20: header
21: header housing
22: header-side signal terminal (first header terminal)
23: header-side power source terminal (second header terminal)
24: header-side retaining fixture
30: socket
31: socket housing
32: socket-side signal terminal (first socket terminal)
33: socket-side power source terminal (second socket terminal)
34: socket-side retaining fixture
35: first inverted U-shaped portion
36: second inverted U-shaped portion
37: third inverted U-shaped portion
40: second circuit board (circuit board)
60: first circuit board (circuit board)
R1 to R5: contact portion
X: longitudinal direction
Y: short direction (width direction)
Z: vertical direction

1. A connector comprising:
a socket including a socket housing having a substantially rectangular shape, the socket housing including a first socket terminal and a second socket terminal disposed in the socket housing, the second socket terminal having a larger width than a width of the first socket terminal; and
a header including a header housing having a substantially rectangular shape, the header housing including a first header terminal and a second header terminal disposed in the header housing, the second header terminal having a larger width than a width of the first terminal;
wherein
the second socket terminal includes one second socket terminal and another second socket terminal,
the one second socket terminal is disposed on one side in a longitudinal direction and on one side in a short direction of the socket housing, and
the another second socket terminal is disposed on another side in the longitudinal direction and on another side in the short direction of the socket housing.

2. The connector according to claim 1,
wherein
a shape of a side surface of the first socket terminal and a shape of a side surface of the second socket terminal have a substantially identical shape, and
the first socket terminal and the second socket terminal are arranged in a row along the longitudinal direction of the socket housing.

3. The connector according to claim 1,
wherein
the first socket terminal is one of a plurality of first socket terminals,
the plurality of first socket terminals are arranged along the longitudinal direction of the socket housing, the plurality of first socket terminals constitute a first socket terminal group, and
the second socket terminal is arranged on an outer side of the first socket terminal group in the longitudinal direction of the socket housing.

4. The connector according to claim 1,
wherein
the first socket terminal includes a first socket-terminal-side contact portion and a first socket-terminal-side fixed portion, the first socket-terminal-side contact portion comes into contact with the first header terminal, the first socket-terminal-side fixed portion is fixed to a circuit board,
the second socket terminal includes a second socket-terminal-side contact portion and a second socket-terminal-side fixed portion, the second socket-terminal-side contact portion comes into contact with the second header terminal, the second socket-terminal-side fixed portion is fixed to the circuit board, and
a distance between the first socket-terminal-side fixed portion and the second socket-terminal-side fixed portion is larger than a distance between the first socket-terminal-side contact portion and the second socket-terminal-side contact portion when the first socket terminal and the second socket terminal are arranged on the socket housing.

5. The connector according to claim 4,
wherein
the second socket terminal includes the second socket-terminal-side contact portions at two positions, and
a cross-sectional area of one of the second socket-terminal-side contact portions is larger than a cross-sectional area of another one of the second socket-terminal-side contact portions, the one of the second socket-terminal-side contact portions is located closer to the second socket-terminal-side fixed portion than the another one of the second socket-terminal-side contact portions.

6. The connector according to claim 1, wherein a thickness of the second socket terminal is thinner than a thickness of the first socket terminal.

7. The connector according to claim 1, wherein the second socket terminal includes an engaging portion to engage the second header terminal.

8. The connector according to claim 7, wherein the second header terminal includes an engaged portion to be engaged by the engaging portion of the second socket terminal.

9. The connector according to claim 1,
wherein
the socket housing includes a socket-side retaining fixture, the socket-side retaining fixture is disposed in the socket housing, and
the second socket terminal is provided separately from the socket side retaining fixture.

10. The connector according to claim 1, wherein the header housing includes a header-side retaining fixture, the header-side retaining fixture is disposed in the header housing, and
the second header terminal and the header-side retaining fixture are integrally provided.

11. The connector according to claim 10, wherein the socket-side holding fixture and the header-side retaining fixture are electrically connected.

12. A socket used for the connector described in claim 1.

13. A header used for the connector described in claim 1.

14. A socket comprising:
a socket housing having a substantially rectangular shape, the socket housing including a first socket terminal and a second socket terminal disposed in the socket housing, the second socket terminal having a larger width than a width of the first socket terminal,
wherein
the second socket terminal includes one second socket terminal and another second socket terminal,
the one second socket terminal is disposed on one side in a longitudinal direction and on one side in a short direction of the socket housing, and
the another second socket terminal is disposed on another side in the longitudinal direction and on another side in the short direction of the socket housing.

15. A header comprising a header housing having a substantially rectangular shape, the header housing including a first header terminal and a second header terminal disposed in the header housing, the second header terminal having a width larger than a width of the first terminal,
wherein
the second header terminal includes one second header terminal and another second header terminal,
the one second header terminal is disposed on one side in a longitudinal direction and on one side in a short direction of the header housing, and
the another second header terminal is disposed on another side in the longitudinal direction and on another side in the short direction of the header housing.
